(19) United States
(12) Patent Application Publication
(10) Pub. No.: US 2018/0308281 A1
(43) Pub. Date: Oct. 25, 2018

(54) 3-D GRAPHIC GENERATION, ARTIFICIAL INTELLIGENCE VERIFICATION AND LEARNING SYSTEM, PROGRAM, AND METHOD

(71) Applicant: draw, Inc., Minato-ku, Tokyo (JP)

(72) Inventor: Yoshiya OKOYAMA, Minato-ku, Tokyo (JP)

(21) Appl. No.: 15/767,648

(22) PCT Filed: Mar. 31, 2017
(86) PCT No.: PCT/JP2017/013600

§ 371 Date: Apr. 12, 2018

(30) Foreign Application Priority Data
Apr. 1, 2016 (JP) 2016-074158

(51) Int. Cl. G06T 15/80; G06T 15/00; G06T 7/11; G06K 9/62; H04N 5/232; G06T 7/187

(52) U.S. Cl. CPC G06T 15/80; G06T 15/005; G06T 7/11; G06K 9/6201; G06T 2207/10016; G06T 7/187; G06T 2200/04; G06T 2207/10004; H04N 5/23248

(57) ABSTRACT

To facilitate rendering a CG image in real time, compositing same with a real photographic video image, and creating interactive content, and also to ensure responsiveness to a user operation. Provided is a 3-D graphic generation system, comprising: a full-sky sphere camera 11 which photographs a background image D2 of a virtual space 4; an actual environment acquisition unit 12b which acquires turntable environment data D1 of an actual site of which photographic material is photographed; an object control unit 254 which generates a virtual three-dimensional object D3 which is positioned within the virtual space 4, and which causes the three-dimensional object D3 to act on the basis of a user operation; an environment reproduction unit 252 which, on the basis of the turntable environment data D1, sets lighting within the virtual space; and a rendering unit 251 which, on the basis of the lighting which is set by the environment reproduction unit 252 and the control which is performed by the object control unit 254, and composites the three-dimensional object upon the photographic material.

### TECHNICAL FIELD

The present invention relates to a 3D graphic generation system, a program and a method for drawing an object arranged in a virtual space as computer graphics. Also, the present invention relates to the verification and learning system, a program and a method for artificial intelligence using a 3D graphic generation system and the like.

### BACKGROUND ART

Conventionally, the technique of creating a video image by synthesizing a CG (computer graphics) image on a real photographic video image which is photographed under a real environment has been developed. When CG is synthesized on this real photographic video image, the CG and the real photographic video image have to be prepared with the same lighting settings in order to combine them without the feeling of incompatibility. For example, Patent Document 1 discloses a technique of setting lighting by adjusting a lighting position and a lighting direction when drawing computer graphics. In the case of the technique disclosed in Patent Document 1, the image of the subject under a lighting environment based on lighting information is generated from the subject information relating to the lighting of the subject and the lighting information which is acquired on the basis of a virtual lighting in a real space.

### PRIOR ART DOCUMENTS

### Patent Documents

[Patent Document 1]
Japanese Patent Published Application No. 2016-6627

### SUMMARY OF THE INVENTION

### Problems to be Solved by the Invention

However, as disclosed in the above described Patent Document 1, even if an illumination position and an illumination direction are reproduced in a virtual space, the feeling of incompatibility occurs to an observer unless the characteristics of CG accord with the characteristics of the entire real photographic video image which depend on a photographing device, a photographic environment, a display device or the like such as the characteristics of a camera which is actually used for photographing a material, response characteristics in the gradation level of an image or the like.

Namely, since the image characteristics are influenced by a variety of factors, it is difficult to make the characteristics of CG perfectly accord with the characteristics of the entire real photographic video image. Also, even if an accord is established therebetween, it depends on subjective views of an operator and requires skilled operations. Particularly, in the case of a system such as a computer game in which a CG object is operated by a user and interactively drawn, the CG object cannot be rendered in advance so that rendering and image synthesizing have to be performed on a real time base. Because of this, when performing rendering and synthesizing processes, there may be a problem that a drawing process is delayed when performing a complicated and highly advanced arithmetic operation to degrade the responsiveness to user operations.

On the other hand, modern automobiles have been developed to be more secure and safe vehicles by assisting driver's decision other than “run, stop and turn” with an Advanced Driving Assist System (ADAS) which is equipped with AI (Artificial Intelligence). This assist system is controlled with AI by acquiring environmental information with various sensing devices such as a vehicle mounted camera and a lader to implement “viewing and measuring” functions to realize therefore higher safety and security. The developers of such an assist system have to perform system verification of these sensing devices by the use of video images and space data. For this purpose, it is needed to analyze an enormous amount of running video images and space data.

Nevertheless, in the case of system verification using real photographic video images and space data, it is very difficult due to the huge amount of data to perform verification by photographing running images and space data in a real situation. Furthermore, verification has to be performed by the use of an environment such as weather which cannot be controlled by a human being, and the situation to be tested is, in the first place, related to a rare case which does not commonly occur in a real world so that, while the scope of video images required for verification is enormous, there is a problem that enormous time and costs are needed to take the real photographic video images.

In order to solve the problem as described above, it is an object of the present invention to provide a 3D graphic generation system, a program and a method wherein it is possible to render a CG image in response to user operations on a real time base, create interactive contents to be synthesized on a real photographed video image, and secure ensure responsiveness to user operations.

Also, it is another object of the present invention to provide an artificial intelligence verification and learning system, a program and a method wherein it is possible to build a virtual environment which is effective to perform artificial intelligence verification and learning by applying the 3D graphic generation system as described above to reproduce the reality for input sensors and build a virtual environment in which the situation to be verified can be controlled.

### Means for Solving Problem

In order to accomplish the object as described above, the present invention is characterized by a 3D graphic generation system in accordance with the present invention comprising:

a material photographing unit which photographs a photographic material which is a still image or a motion picture of a material arranged in a virtual space;

a real environment acquisition unit which acquires turntable environment information containing any of a lighting position, a lighting type, a lighting amount, a lighting color and the number of light sources at a work site where the photographic material is photographed, and real camera profile information which describes specific characteristics of the material photographing unit which is used to photograph the photographic material;

an object control unit which generates a virtual three-dimensional object arranged in the virtual space, and makes the three-dimensional object move in response to user operations;

an environment reproduction unit which acquires the turntable environment data, sets lighting for the three-dimensional object in the virtual space on the basis of the turntable environment data which is acquired, and adds the real camera profile information to photographing settings of a virtual photographing unit which is arranged in the virtual space to photograph the three-dimensional object; and

a rendering unit which synthesizes a three-dimensional object with the photographic material, which is photographed by the material image photographing unit, and draws the three-dimensional object in order that the three-dimensional object can be two-dimensionally displayed, on the basis of the lighting and photographing settings set by the environment reproduction unit.

Also, a 3D graphic generation method in accordance with the present invention comprising:

a process of photographing a photographic material which is a still image or a motion picture of a material arranged in a virtual space by a material photographing unit, and acquiring, by a real environment acquisition unit, turntable environment information containing any of a lighting position, a lighting type, a lighting amount, a lighting color and the number of light sources at a work site where the photographic material is photographed, and real camera profile information which describes specific characteristics of the material photographing unit which is used to photograph the photographic material;

a process of, by an environment reproduction unit, acquiring the turntable environment data, setting lighting for the three-dimensional object in the virtual space on the basis of the turntable environment data which is acquired, and adding the real camera profile information to photographing settings of a virtual photographing unit which is arranged in the virtual space to photograph a three-dimensional object; and

a process of, by an object control unit, generating a virtual three-dimensional object arranged in the virtual space, and making the three-dimensional object move in response to user operations; and

a process of, by a rendering unit, synthesizing a three-dimensional object with the photographic material, which is photographed by the material image photographing unit, and drawing the three-dimensional object in order that the three-dimensional object can be two-dimensionally displayed, on the basis of the lighting and photographing settings set by the environment reproduction unit.

In accordance with these inventions, while actually photographing a real place as a model of the background of a virtual space with the material photographing apparatus and acquiring the turntable environment data containing any of a lighting position, a lighting type, a lighting amount, a lighting color and the number of light sources in the real place, and real camera profile information which describes specific characteristics of the material photographing unit which is used to photograph the real place, three-dimensional objects drawn as computer graphics are synthesized with the photographic material photographed by the material image photographing unit on the basis of the acquired information and drawn in order that the synthesized image can be two-dimensionally displayed. At this time, lighting is set for the three-dimensional object in the virtual space on the basis of the turntable environment data, and the real camera profile information is added to photographing settings of the virtual photographing unit to reproduce the photographing environment at the work site.

In accordance with the present invention, thereby, lighting and the specific characteristics of the camera can automatically be made match the real environment at the work site when rendering computer graphics so that lighting setting can be performed without depending on subjective views of an operator and requiring skilled operations. Since lighting can be automatically set, rendering and synthesizing processes can be performed on a real time base even in the case of a system such as a computer game which interactively draws images in response to user operations of a CG object.

In the case of the above invention, it is preferred that the material photographing unit has a function to photograph images in multiple directions to form a background image in the form of a full-sky sphere,

that the real environment acquisition unit has a function to acquire the turntable environment information in the multiple directions and reproduce a light source in a real space including the work site, and

that the rendering unit joins the photographic material in the form of a full-sky spherical image with a view point position of a user as a center, synthesizes and draws the three-dimensional object on the joined full-sky spherical background images.

In this case, the present invention can be applied to the so-called VR (Virtual Reality) system which projects full-sky spherical images. For example, it is possible to build an interactive system such as a game which operates a three-dimensional object in response to user operations of a full-sky sphere image by reproducing a 360° virtual world with a head mount display (HMD) which is worn on the head of an operator to cover the view.

In the case of the above invention, it is preferred to provide a known light distribution theoretical value generation unit which generates, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;

an in-situ theoretical value generation unit which generates in-situ theoretical values at the work site, from which is deducted a characteristic specific to the material photographing unit, on the basis of an image characteristic of a photographic material obtained by photographing the known material at the work site and the real camera profile information relating to the material photographing unit; and

an evaluation unit which generates evaluation axis data by quantitatively calculating the matching degree between the known light distribution theoretical values and the in-situ theoretical values, wherein

when the three-dimensional object is synthesized with the photographic material, the rendering unit performs a process to match the image characteristics of the photographic raw material and three-dimensional object with reference to the evaluation axis, followed by performing the synthesizing process.

In this case, the synthesizing process can be performed by comparing the characteristics of the image by photographing a known material, whose physical properties are known, under a known light distribution condition with the characteristics of the image by photographing the known material placed on the work site, generating the evaluation axis and performing a process to match both characteristics with reference to this evaluation axis. As a result, since lighting and the specific characteristics of a camera can be quantitatively evaluated, it is possible to make lighting match the real environment at the work site without depending on subjective views of an operator. Also, since the evaluation axis is used for matching, it is possible to guarantee matching with respect to other physical properties and image characteristics and facilitate the evaluation of the synthesized image.

Furthermore, the present invention is related to an artificial intelligence verification and learning system and method which performs predetermined motion control on the basis of image recognition through a camera sensor, comprising:

a material photographing unit which photographs, as a photographic material, a still image or a motion picture of a real object equivalent to a material arranged in a virtual space;

a real environment acquisition unit which acquires turntable environment information containing any of a lighting position, a lighting type, a lighting amount, a lighting color and the number of light sources at a work site where the photographic material is photographed, and real camera profile information which describes specific characteristics of the camera sensor;

an object control unit which generates a virtual three-dimensional object arranged in the virtual space, and makes the three-dimensional object move on the basis of the motion control by the artificial intelligence;

an environment reproduction unit which acquires the turntable environment data, sets lighting for the three-dimensional object in the virtual space on the basis of the turntable environment data which is acquired, and adds the real camera profile information to photographing settings of a virtual photographing unit which is arranged in the virtual space to photograph the three-dimensional object;

a rendering unit which synthesizes a three-dimensional object with the photographic material, which is photographed by the material photographing unit, and draws the three-dimensional object in order that the three-dimensional object can be two-dimensionally displayed, on the basis of the lighting and photographing settings set by the environment reproduction unit; and

an output unit which inputs graphics drawn by the rendering unit to the artificial intelligence.

In the case of the above invention, it is preferred to provide a known light distribution theoretical value generation unit which generates, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;

an in-situ theoretical value generation unit which generates in-situ theoretical values at the work site, from which is deducted a characteristic specific to the material photographing unit, on the basis of an image characteristic of a photographic material obtained by photographing the known material at the work site and the real camera profile information relating to the material photographing unit; and

an evaluation unit which generates evaluation axis data by quantitatively calculating the matching degree between the known light distribution theoretical values and the in-situ theoretical values.

Also, in the case of the above invention, it is preferred to further provide a comparison unit which inputs graphics drawn by the rendering unit to the artificial intelligence having learned teacher data by the use of actually photographed materials, and compares reaction of the artificial intelligence to the actually photographed materials with reaction of the artificial intelligence to the graphics.

Furthermore, in the case of the above invention, it is preferred to further provide a segmentation unit which performs area segmentation for a particular object in an image to be recognized with respect to the graphics drawn by the rendering unit;

an annotation creation unit which associates an area image which is area segmented with a particular object; and

a teacher data creation unit which creates teacher data for learning by associating the area image with annotation information.

Still further, in the case of the above invention, it is preferred that a sensor unit having a different characteristic than the camera sensor is provided, that

the real environment acquisition unit acquires the detection result of the sensor unit having the different characteristic together with the turntable environment information, that

the rendering unit generates a 3D graphics image on the basis of information obtained from each of the sensors having the different characteristics, and that

The artificial intelligence comprises:

a unit which performs deep learning recognition by receiving 3D graphics images;

a unit which outputs a deep learning recognition result for each of the sensors; and

a unit which analyzes the deep learning recognition result for each of the sensors and selects one or more result from among the deep learning recognition results.

Also, the system of the present invention as described above can be implemented by running a program which are written in an appropriate language on a computer. The 3D graphics generation system having the functions as described above can be easily built by installing such a program in a computer such as a user terminal or a Web server and executing the program on a CPU.

This program can be distributed, for example, through a communication line, or as a package application which can be run on a stand-alone computer by storing the program in a storage medium which can be read by a general purpose computer. Specifically, such a storage medium includes a magnetic recording medium such as a flexible disk or a cassette tape, an optical disc such as CD-ROM or DVD-ROM, a RAM card and a variety of storage mediums. In addition, in accordance with the computer readable medium in which this program is stored, the above system and method can be easily implemented with a general purpose computer or a dedicated computer, and the program can be easily maintained, transported and installed.

### Effects of the Invention

As has been discussed above, in accordance with the present invention, when synthesizing a CG (computer graphics) image on a real photographic video image which is photographed under a real environment, it is possible to render a CG image in response to user operations on a real time base, create interactive contents to be synthesized on a real photographed video image, and ensure responsiveness to user operations.

Also, in accordance with the artificial intelligence verification and learning system of the present invention, it is possible to build a virtual environment which is effective to perform artificial intelligence verification and learning by applying the 3D graphic generation system as described above to reproduce the reality for input sensors and build a virtual environment in which the situation to be verified can be controlled.

In other words, in accordance with the artificial intelligence verification and learning system of the present invention, it is possible to use real CG synthesized images as teacher data for learning in the same manner as using a real photographed video image. By this configuration, since teacher data for learning can be drastically increased for realizing an automatic driving system, there is an advantage of enhancing a learning effect. Particularly, in the case of the present invention, since realistic CG images are generated by the use of real CG synthesized images generated on the basis of various parameter information extracted from real photographed images, it is possible to improve the recognition ratio as compared with the case utilizing real photographed images by the use of the high reality of real CG synthesized images in the field in which the resource is significantly deficient such as real running data for realizing an automatic driving system.

### BRIEF DESCRIPTION OF THE DRAWINGS

FIG. 1 is a block diagram for schematically showing the overall configuration of a 3D graphic generation system in accordance with a first embodiment.

FIG. 2 is a flow chart for showing the operation of the 3D graphic generation system in accordance with the first embodiment.

FIG. 3 is an explanatory view for showing a synthesizing process in the 3D graphic generation system in accordance with the first embodiment.

FIG. 4 is an explanatory view for showing 3D graphics generated in accordance with the first embodiment.

FIG. 5 is an explanatory view for showing gamma correction in conventional cases.

FIG. 6 is an explanatory view for explaining gamma correction in accordance with the first embodiment.

FIG. 7 is a flow chart for showing the flow of physical texturing in accordance with the first embodiment.

FIG. 8 is a schematic representation for showing the flow of operation of an evaluation unit in accordance with the first embodiment.

FIG. 9 is a schematic representation showing a basic mechanism of AI verification and learning in accordance with a second embodiment.

FIG. 10 is a block diagram for showing the relationship between an advanced driving support system and a 3D graphic generation system in accordance with the second embodiment.

FIG. 11 is a schematic block diagram for showing the overall configuration of the 3D graphic generation system and the advanced driving support system in accordance with the second embodiment.

FIG. 12 is an explanatory view for showing the summary of a recognition process by a recognition function module in accordance with the second embodiment.

FIG. 13 is an explanatory view for showing a walker recognition result from a CG image of a system in accordance with the second embodiment.

FIG. 14 is an explanatory view for showing an example of teacher data generated by the system in accordance with the second embodiment.

FIG. 15 is a block diagram for showing the configuration of a deep learning recognition unit in accordance with the second embodiment.

FIG. 16 is a block diagram for showing the configuration of a teacher data creation unit in accordance with the second embodiment.

FIG. 17 is an explanatory view for explaining an object and coloring distinction in each area when segmentation is performed during creation of teacher data in accordance with the second embodiment.

FIG. 18 is an explanatory view for explaining target objects on a road which are distinguished by color when segmentation is performed during creation of teacher data in accordance with the second embodiment.

FIG. 19 is an explanatory view for explaining an annotation process during creation of teacher data in accordance with the second embodiment.

FIG. 20 is a flow chart for showing the operation of the 3D graphic generation system in accordance with the second embodiment.

FIG. 21 is an explanatory view for showing the synthesizing process for generating 3D graphics in accordance with the second embodiment.

FIG. 22 is a block diagram for showing the configuration of a deep learning recognition unit in accordance with a modification example 1 of the second embodiment.

FIG. 23 is a block diagram for showing the configuration of a deep learning recognition unit in accordance with a modification example 2 of the second embodiment.

FIG. 24 is a block diagram for showing the configuration of a 3D graphic generation system in accordance with the modification example 2 of the second embodiment.

FIG. 25 is an explanatory view for showing a 3D graphic image of 3D point group data generated by a LiDAR in accordance with the modification example 2 of the second embodiment.

### MODE FOR CARRYING OUT THE INVENTION

### First Embodiment

In what follows, with reference to the accompanying drawings, a first embodiment of 3D graphic generation in accordance with the present invention will be explained in detail. Incidentally, the embodiment described below has been disclosed with devices and the like by way of illustration for implementing the technical idea of the present invention, which is not limited to the material, formation, structure, arrangement of each constituent member as described below. The technical idea of the present invention can be modified within the scope of claims.

(Structure of 3D Graphic Generation System)

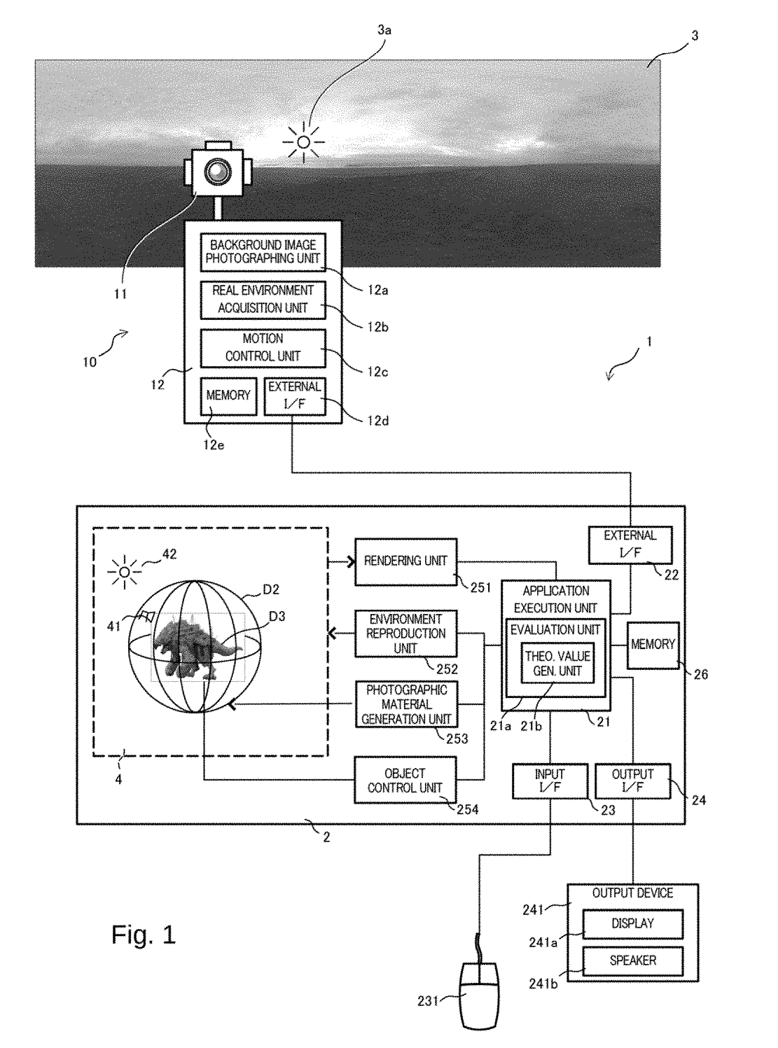

FIG. 1 is a block diagram for schematically showing the overall configuration of a 3D graphic generation system in accordance with the present embodiment. As shown in FIG. 1, the 3D graphic generation system in accordance with the present embodiment is composed mainly of a material photographing apparatus 10 which photographs an actual site scenery 3 in a real world as a photographic material which is a still image or a motion picture for use in the background of a virtual space, and a 3D application system 2 for presenting interactive video content such as games.

The material photographing apparatus 10 is a material photographing unit which photographs photographic materials which are a background, a still image or a motion picture of a material to be arranged in a virtual space 4, and is composed of a full-sky sphere camera 11 and a motion control device 12 which controls the motion of the full-sky sphere camera 11.

The full-sky sphere camera 11 is a photographing apparatus which can photograph a 360-degree panoramic image to simultaneously take a plurality of omnidirectional photographs and motion pictures with the view point of the operator as a center point. The full-sky sphere camera 11 may be of a type including a plurality of cameras combined in order to perform full field photographing, or a type including two fisheye lenses which have a 180° wide-angle visual field and are arranged on the front and back sides.

The motion control device 12 is a device which controls the motion of the full-sky sphere camera 11 and analyzes still images and video images which are photographed, and can be implemented with an information processing apparatus such as a personal computer or a smartphone connected to the full-sky sphere camera 11. The motion control device 12 is provided with a material image photographing unit 12a, a real environment acquisition unit 12b, a motion control unit 12c, an external interface 12d and a memory 12e.

The material image photographing unit 12a is a module for photographing a background image D2 which is a still image or a motion picture to be used as a background of the virtual space 4 through the full-sky sphere camera 11, and storing the photographed data in the memory 12e.

The real environment acquisition unit 12b is a module for acquiring turntable environment information containing any of a lighting position, a lighting type, a lighting amount and the number of light sources at the work site where a photographic material is photographed by the material image photographing unit 12a. The system and apparatus for acquiring turntable environment information may be implemented with various sensors which detects an omnidirectional light quantity and the type of the light source. And, the position, direction, type, intensity (light quantity) and the like of the light source are calculated as turntable environment information by analyzing still images and motion pictures photographed by the full-sky sphere camera 11.

Furthermore, the real environment acquisition unit 12b generates real camera profile information which describes the specific characteristics of the material photographing unit for use in photographing. Meanwhile, in this case, while the turntable environment information and the real camera profile information are generated by the real environment acquisition unit 12b in the above example, such information may be accumulated in advance or downloaded through a communication network such as the Internet.

The motion control unit 12c manages and controls the overall operation of the motion control device 12, and accumulates photographic materials, which are photographed, and the turntable environment information, which is acquired when photographing the photographic materials, are accumulated in the memory 12e in association with each other and transmitted to the 3D application system 2 through the external interface 12d.

On the other hand, for example, the 3D application system 2 can be implemented with an information processing apparatus such as a personal computer which, in the case of the present embodiment, can build the 3D graphic generation system of the present invention by executing a 3D graphic generation program of the present invention.

The 3D application system 2 is provided with an application execution unit 21. This application execution unit 21 is a module for executing applications such as general software, the 3D graphic generation program of the present invention and so forth, and usually implemented with a CPU or the like. Meanwhile, in the case of the present embodiment, various modules for generating 3D graphics are virtually built on the CPU, for example, by executing the 3D graphic generation program in the application execution unit 21.

The application execution unit 21 are connected to an external interface 22, an output interface 24, an input interface 23 and a memory 26. Furthermore, in the case of the present embodiment, the application execution unit 21 is provided with an evaluation unit 21a.

The external interface 22 is an interface for transmitting and receiving data to/from external devices, for example, through an USB terminal and/or a memory card slot, and includes a communication interface for performing communication in the case of the present embodiment. The communication interface is provided, for example, for performing communication through a wireless public telephone network such as a wired/wireless LAN, 4G, LTE or 3G, Bluetooth (registered trademark) or infrared communication, and for performing an IP network communication using the communication protocol TCP/IP such as the Internet.

The input interface 23 is used to connect a device such as a keyboard, a mouse, a touch panel and the like for inputting user operations, sound, radio waves, light (infrared rays and ultraviolet rays) and the like. Also, a camera, a microphone or the like sensor can be connected through the input interface 23. The output interface 24 is a device for outputting video images, sounds or other signals (infrared rays, ultraviolet rays, radio waves and the like). In the case of the present embodiment, the output interface 24 is used to connect a display 241a such as a liquid crystal screen and/or a speaker 241b. An object which is generated is displayed on this display 241a, and sounds which is generated on the basis of sound data is output through the speaker 241b in synchronization with the motion of the object.

The memory 26 is a storage device for storing an OS (Operating System), firmware, programs for executing various applications, other data and the like. Particularly, the 3D graphic program in accordance with the present invention is stored in this memory 26. This 3D graphic program is installed from a recording medium such as a CD-ROM, or installed by downloading the program from a server on a communication network.

A rendering unit 251 is a module for performing arithmetic operations of a data set (numerals, parameters of formulas, descriptors of drawing rules, and the like) described by a data structure or a data description language for designating an image and the contents of a screen to draw a set of picture elements which can be two-dimensionally displayed. In the case of the present embodiment, the rendering unit 251 synthesizes a three-dimensional object for a photographic material to draw a set of picture elements which can be two-dimensionally displayed. The information for use in this rendering includes the shape of an object, the view point from which the object is viewed, surface texture of the object (information about texture mapping), a light source, shading conditions and the like. A three-dimensional object is synthesized with a photographic material, which is photographed by the material image photographing unit 12a, and drawn in order that it can be two-dimensionally displayed, on the basis of lighting settings made by an environment reproduction unit 252 and the control by an object control unit 254.

The environment reproduction unit 252 is a module for acquiring turntable environment data D1 and setting lighting for the three-dimensional object in the virtual space 4 on the basis of the turntable environment data which is acquired. This environment reproduction unit 252 adjusts a gamma curve and the like with reference to the positions, type, light amount and the number of a light source 42 which is set on the coordinates in the virtual space 4, and also with reference to the turntable environment data D1 in the case of the present embodiment. Furthermore, the environment reproduction unit 252 adds real camera profile information to the photographing settings of a virtual camera which is arranged in the virtual space 4 to photograph a three-dimensional object, and adjusts the photographing settings in order to make the characteristics of the virtual camera match the characteristics of the real camera which is actually used in the place.

A photographic material generation unit 253 is a module for generating or acquiring a photographic material which is a still image or a motion picture to be used as a background of the virtual space. This photographic material as acquired is a 3D material which is photographed by the material image photographing unit 12a or created by a 3D material creation application executed by the application execution unit 21.

The object control unit 254 is a module for generating a virtual three-dimensional object arranged in the virtual space 4, and making the three-dimensional object move in response to user operations. Specifically, while moving the three-dimensional object D3 on the basis of operation signals input through the input interface 23, the object control unit 254 calculates the relationship to the camera view point 41, the light source 42 and the background image D2 as the background in the virtual space 4. The rendering unit 251 generates the background image D2 by joining a photographic material to the full-sky sphere with the camera view point 41 as a center, i.e., a view point position of a user, and synthesizes and draws the three-dimensional object D3 on the background image D2 as generated on the basis of the control of this object control unit 254.

The evaluation unit 21a is a module for quantitatively calculating the matching degree between known light distribution theoretical values and in-situ theoretical values to generate evaluation axis data, and evaluating, when compositing a material photographed at the work site and a rendered 3D material, the matching therebetween with respect to light distribution and image characteristics. In the case of the present embodiment, the evaluation unit 21a is provided with a theoretical value generation unit 21b.

This theoretical value generation unit 21b is a module for generating theoretical values from which are deducted the specific characteristics of a camera (real camera), which physically exists, on the basis of the characteristics of an image which are photographed by the real camera and the specific characteristics of the real camera. In the case of the present embodiment, the theoretical value generation unit 21b generates known light distribution theoretical values relating to an image obtained by photographing a known material, as an object whose physical properties are known, by using a real camera under a known light distribution condition, and in-situ theoretical values relating to an image obtained by photographing this known material at the work site.

(3D Graphic Generation Method)

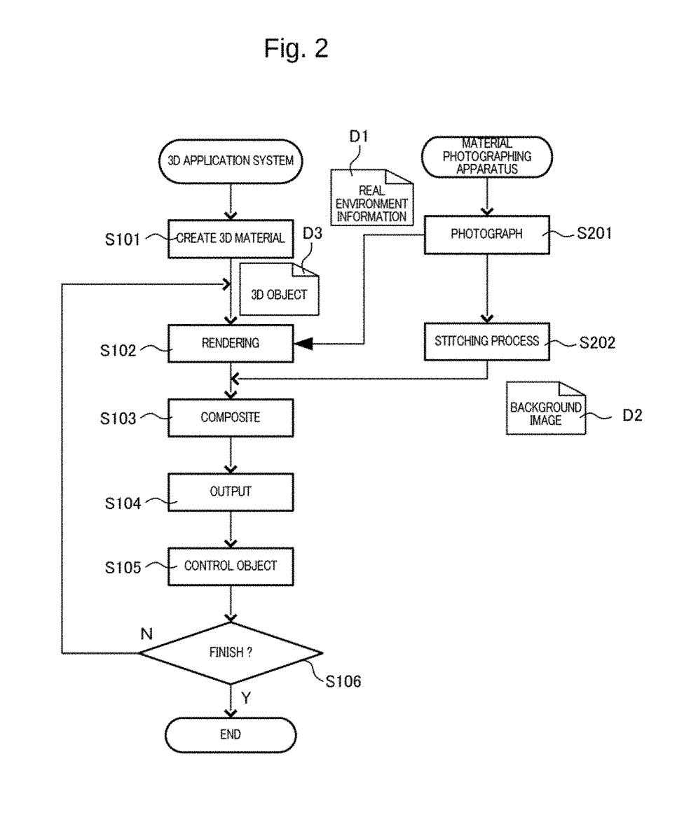

The 3D graphic generation method of the present invention can be implemented by operating the 3D graphic generation system having the structure as described above. FIG. 2 is a flow chart for showing the operation of the 3D graphic generation system in accordance with the present embodiment.

First, a 3D material is created as a 3D object (S101). This 3D material creation is performed by the use of CAD software or graphic software to define a three-dimensional shape, structure, surface texture and the like of an object with a data set (object file) described by a data structure or a data description language.

While creating this 3D material, a photographic material is photographed (S201). When photographing this photographic material, the material photographing apparatus 10 controls the full-sky sphere camera 11 to photograph a plurality of photographs and motion pictures at the same time in all directions from a center point which is the view point of an operator. In this case, the real environment acquisition unit 12b acquires turntable environment information D1 containing any of a lighting position, a lighting type, a lighting amount and the number of light sources at the work site where a photographic material is photographed by the material image photographing unit 12a. On the other hand, the material image photographing unit 12a performs a stitching process to splice the photographic materials, which are photographed, together on the full-sky sphere (S202). Then, the background image D2 after the stitching process and the turntable environment data D1 acquired at this time are accumulated in the memory 12e in association with each other, and transmitted to the 3D application system 2 through the external interface 12d.

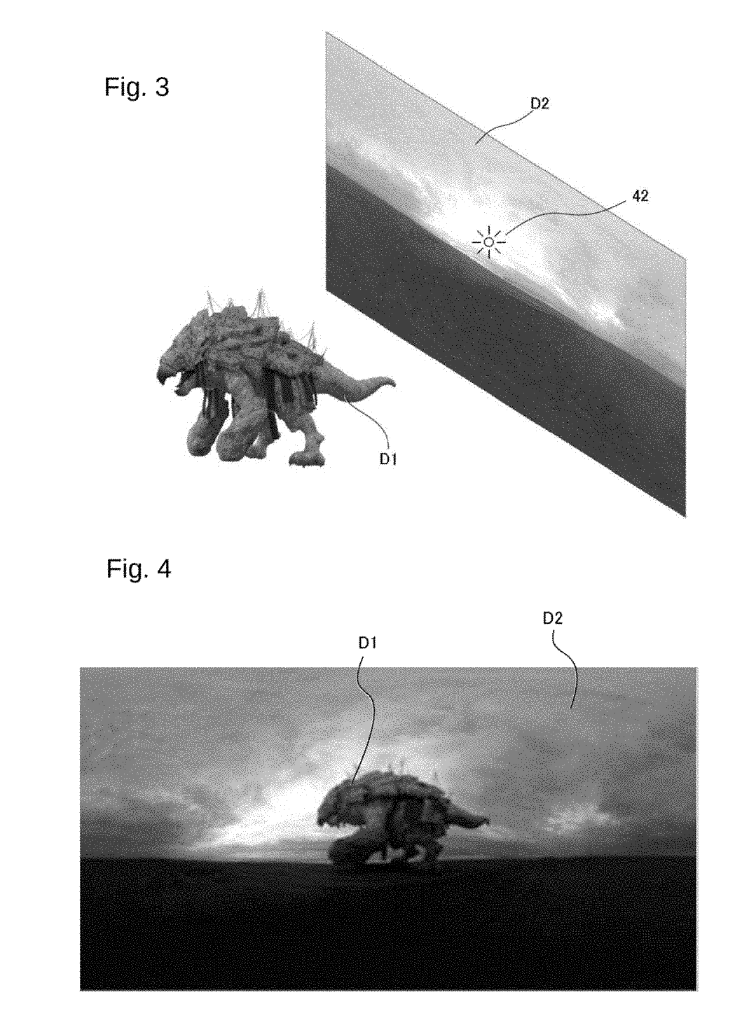

Next, the three-dimensional object created in step S101 is rendered (S102). When performing rendering, the rendering unit 251 performs an arithmetic operation of an object file to draw the three-dimensional object D3 which is a set of picture elements which can be two-dimensionally displayed. Also, as illustrated in FIG. 3, this rendering is carried out to perform processes relating to the shape of an object, the view point from which the object is viewed, surface texture of the object (information about texture mapping), a light source, shading and the like. In this case, the rendering unit 251 performs lighting, which is set by the environment reproduction unit 252, for example by arranging the light source 42 on the basis of the turntable environment data D1.

Then, as illustrated in FIG. 4, the rendering unit 251 performs a composite process which combines the three-dimensional object D3 with the background image D2 photographed by the material image photographing unit 12a to draw the combined image in order that it can be two-dimensionally displayed (S103).

Thereafter, the background image D2 in the form of a full-sky sphere and the three-dimensional object D3, which are drawn and combined in these steps, are displayed on an output device such as the display 241a (S104). A user can control the three-dimensional object D3 by inputting operation signals to this three-dimensional object D3 as displayed (S105).

The process in steps S102 to S105 is repeated (“N” in step S106) until the application is finished (“Y” in step S106). Incidentally, when a user operation is input to the three-dimensional object D3 in step S104, the object control unit 254 performs moving, deforming and/or the like of the three-dimensional object in response to this user operation, followed by performing the next rendering process (S102) with the moved/deformed three-dimensional object.

Meanwhile, when performing the rendering process in step S102 as described above in the case of the present embodiment, lighting is input from the real environment, and assets are built on a physical basis to obtain correct rendering results. Specifically, the following processes are performed.

(1) Linearization

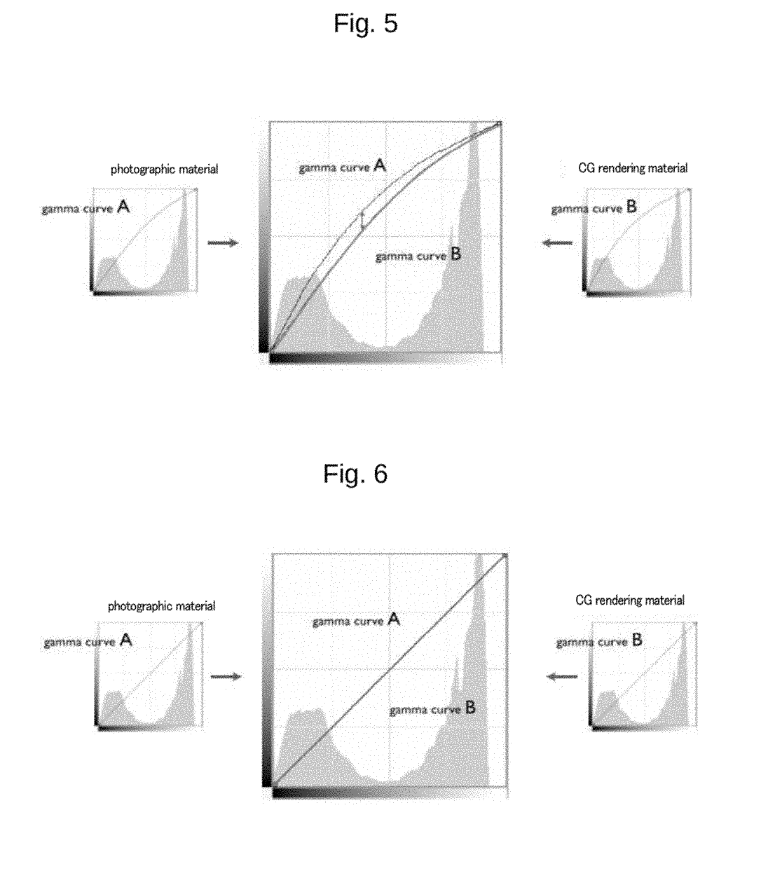

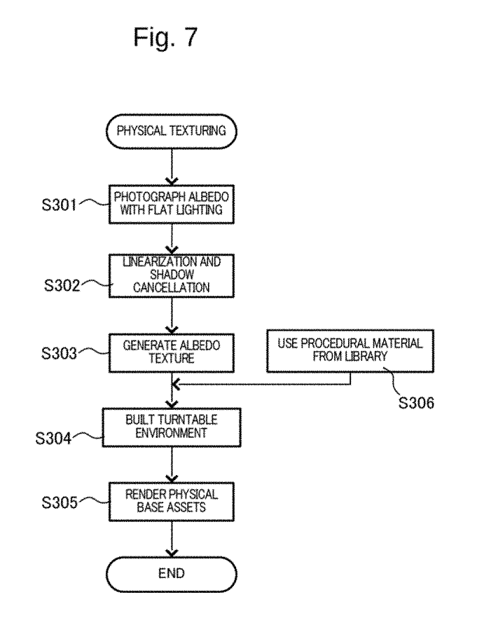

Next is an explanation of correction with respect to response characteristics of image gradation performed by the above described rendering process (S102) and composite process (S103). FIG. 5 is an explanatory view for showing mismatch between gamma curves in conventional cases. FIG. 6 is an explanatory view for showing linear correction of gamma curves performed in accordance with the present embodiment.

Generally speaking, when synthesizing a photographic material photographed under a real environment with a CG rendering material drawn by a computer graphics technique, even if a lighting position and a lighting direction are reproduced in a virtual space, there is a difference therebetween in gamma curve indicative of response characteristics of image gradation as illustrated in FIG. 5. In the case of the illustrated example, the gamma curve A of the photographic material does not match the gamma curve B of the CG rendering material so that an observer feels incompatibility.

For this reason, in the case of the present embodiment, as illustrated in FIG. 6, the gamma curve A of the photographic material and the gamma curve B of the CG rendering material are adjusted (linearization) in order that they becomes straight lines having the common inclination, followed by the compositing process. It is therefore possible to significantly reduce the arithmetic operation required for making the gamma curve A of the photographic material match the gamma curve B of the CG rendering material, and make the gamma curves A and B exactly coincide. As a result, it is possible to resolve the feeling of incompatibility of an observer when synthesizing a CG rendering material drawn by a computer graphics technique.

(2) Physical Texturing

Also, in the case of the present embodiment, physical texturing is performed in the above 3D material creating process (S101) and rendering process (S102). Meanwhile, in the case of the present embodiment, texture mapping is performed by applying a two-dimensional image to the surface of a so-called polygon of a 3D object for the purpose of giving the feeling of a texture to the surface of the polygon.

First, in the case of the present embodiment, an article in the real world is photographed with flat lighting as well as the albedo of the material (S301). This albedo is the ratio of reflected light to incident light from the outside of the article, and can be obtained as a stabilized general value by making use of uniformly distributed light without unevenness. At this time, linearization and shadow cancellation are performed. These linearization and shadow cancellation are performed in order that, while lighting is made flat without deviation to prevent luster from occurring, an existing article is photographed at such an angle that no shadow is reflected on the photograph. Furthermore, image quality is made uniform by software, and luster and shadow are deleted by image processing. Thereafter, albedo texture is generated (S303) which is suitable for general use by flat lighting, linearization and shadow cancellation. Incidentally, in the case where there is such an albedo texture suitable for general use in a library, this albedo texture can be used (S306) as a procedural material to simplify the procedure.

Then, when rendering a three-dimensional object, a turntable environment for reproducing lighting in the real world is built (S304). In this turntable environment, lighting of asset creation is unified among different software programs. In this unified lighting environment, hybridization of prerendering and real time rendering is performed. Physical base assets photographed and created in this environment are rendered (S305).

(3) Matching Evaluation Process

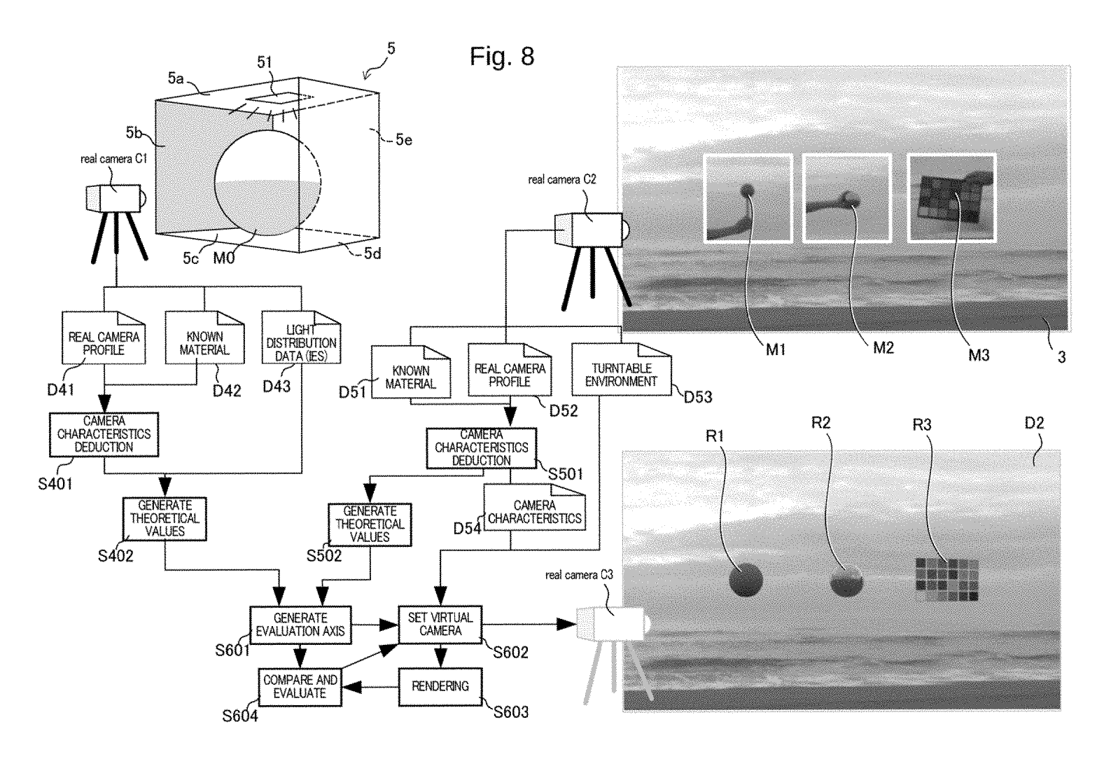

Also, in the case of the present embodiment, when compositing a material which is photographed at the work site and a 3D material which is rendered, an evaluation process is performed to evaluate matching of light distribution and image characteristics therebetween. FIG. 8 is an explanatory view for showing the procedure of the matching evaluation process in accordance with the present embodiment.

First, a known material M0 which is an actual object whose physical properties are known is photographed by a real camera C1 which actually exists under a known light distribution condition. Photographing of the known material M0 is performed in a photographing studio installed in a cubic chamber 5 which is called a Cornell box in which the object is placed to construct a CG test scene. This Cornell box 5 is composed of a deep side white wall 5e, a white floor 5c, a white ceiling 5a, a left side red wall 5b, a right side green wall 5d. Lighting 51 is installed on the ceiling 5a to provide such a lighting setting that indirect light reflected from the left and right side wall faintly irradiates the object placed in the center of the box.

A known material image D43 obtained by this real camera C1 and light distribution data (IES: Illuminating Engineering Society) D42 of the Cornell box, and a specific profile D41 of the real camera C1 which is used for photographing are input to the evaluation unit 21a. In this case, the light distribution data D42 may be provided, for example, in a IES file format and includes the inclination angle (vertical angle, resolution angle in a horizontal plane) of the lighting 51 installed in the Cornell box 5, a lamp output (illuminance value, luminous intensity), emission dimensions, emission profile, emission area, the symmetry of an area profile and the like. Also, the profile D41 of the camera is a data file in which are described a color tendency (hue and saturation) specific to the model of each camera, white balance, set values of camera calibration such as color casting correction.

On the other hand, also, known materials (a gray ball M1, a silver ball M2 and a Macbeth chart M3) whose physical properties are known are photographed by a real camera C2 which actually exists in an actual site scenery 3. Photographing of these known materials M1 to M3 is performed under a light source in the actual site scenery 3, and the light distribution thereof is stored as turntable environment data D53. A known material image D51 obtained by this real camera C2, the turntable environment data D53 and the specific profile D52 of the real camera C2 which is used for photographing are input to the evaluation unit 21a.

Then, the theoretical value generation unit 21b generates known light distribution theoretical values under known light distribution in the Cornell box 5 (S402) by deducting the model specific characteristics of the real camera C1 from the known material image D43 on the basis of the profile D41 of the real camera C1 (S401), and generates in-situ theoretical values under light distribution in the actual site scenery 3 (S502) by deducting the model specific characteristics of the real camera C2 from the known material image D51 on the basis of the profile D52 of the real camera C2 (S501). Incidentally, the camera characteristic D54 of the real camera C2 separated in step S502 is used in a virtual camera setting process (S602).

Then, the evaluation unit 21a quantitatively calculates the matching degree between the known light distribution theoretical values obtained in step S402 and the in-situ theoretical values obtained in step S502 to generate evaluation axis data. Then, when performing the rendering process S102 and the composite process S103, the camera characteristic D54 is reflected in the settings of a virtual camera C3 arranged in a virtual space (S602), and the turntable environment data D53 is reflected in the settings of lighting, followed by performing rendering in these settings (S603). At this time, in step S603, three-dimensional objects (a virtual gray ball R1, a virtual silver ball R2 and a virtual Macbeth chart R3) are synthesized on the background image D2, compared and evaluated with reference to the evaluation axis data (S604), and processed in order that the image characteristics of the photographic material and three-dimensional object match. Incidentally, the accuracy can be improved by reflecting the result of the comparison/evaluation process in the virtual camera settings (S602) and repeating the process in steps S602 to S604.

(Actions/Effects)

In accordance with the present embodiment as has been discussed above, while actually photographing a real place as a model of the background of a virtual space with the material photographing apparatus 10 and acquiring the turntable environment data D1 containing any of a lighting position, a lighting type, a lighting amount and the number of light sources in the real place, three-dimensional objects D3 drawn as computer graphics are synthesized with the photographic material photographed by the material image photographing unit 12a and drawn in order that the synthesized image can be two-dimensionally displayed. At this time, lighting for the three-dimensional objects in the virtual space is set on the basis of the turntable environment data D1. In accordance with the present embodiment, thereby, lighting can automatically be made match the real environment at the work site when rendering computer graphics so that lighting setting can be performed without depending on subjective views of an operator and requiring skilled operations. Since lighting can be automatically set, rendering and synthesizing processes can be performed on a real time base even in the case of a system such as a computer game which interactively draws images in response to user operations of a CG object.

Also, in the case of the present embodiment, it is possible to apply the present invention to a so-called VR system which projects images on a full-sky sphere. For example, it is possible to build an interactive system such as a game which operates a three-dimensional object in response to user operations of a full-sky sphere image by reproducing a 360° virtual world with a head mount display which is worn on the head of an operator to cover the view.

Furthermore, in the case of the present embodiment, since a synthesizing process is performed with reference to evaluation axis data by quantitatively evaluating lighting and the specific characteristics of a camera, it is possible to make lighting match the real environment at the work site without depending on subjective views of an operator. Also, since the evaluation axis is used for matching, it is possible to guarantee matching with respect to other physical properties and image characteristics and facilitate the evaluation of the synthesized image.

### Second Embodiment

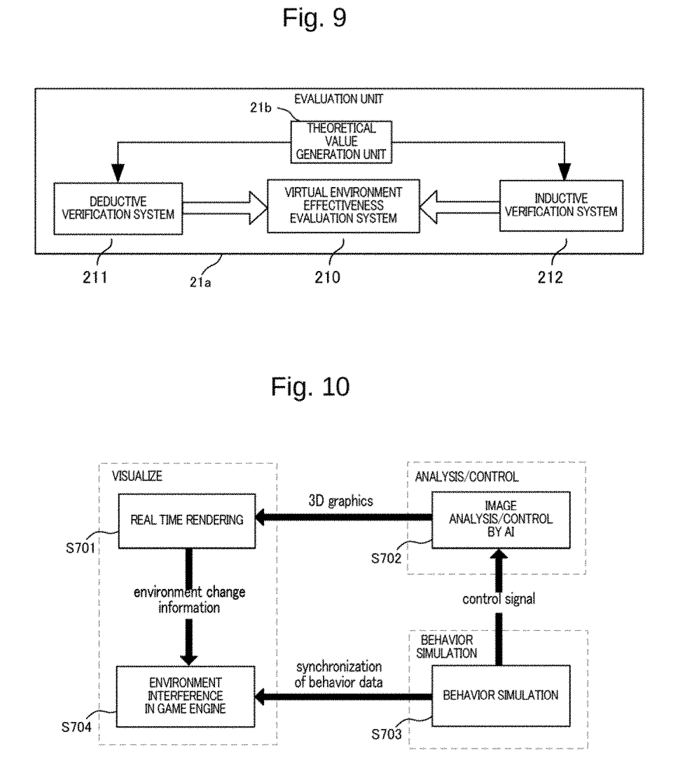

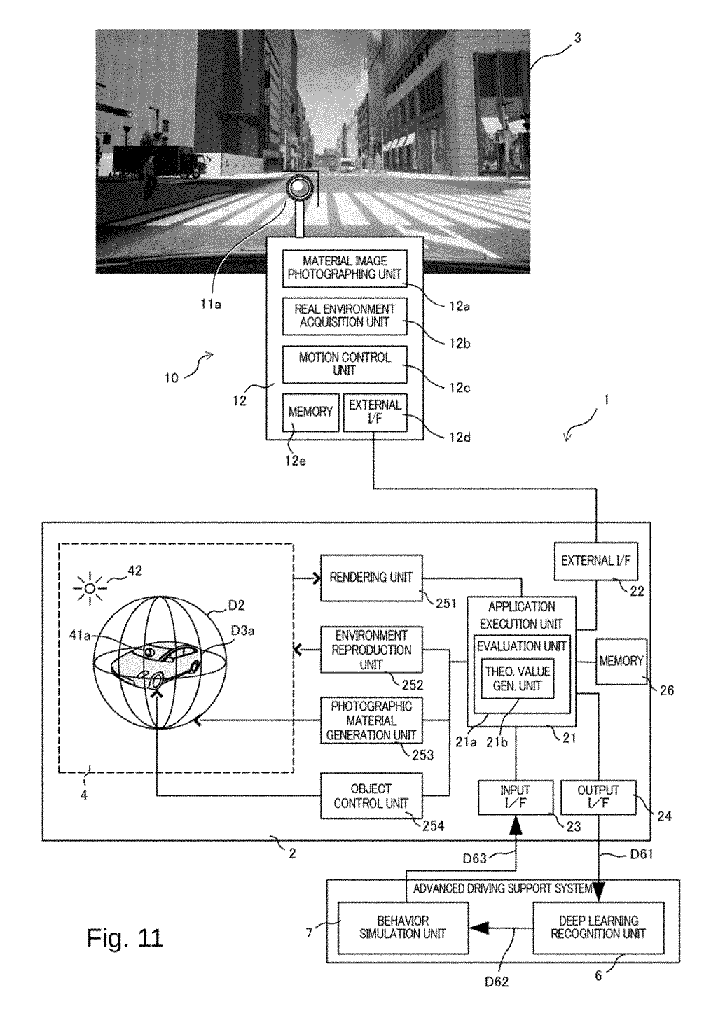

Next, a second embodiment of the present invention will be explained. The present embodiment will be explained as an example of AI functional verification and AI learning installed in an advanced driving support system to which is applied the 3D graphic generation system described above as the first embodiment. FIG. 9 is a schematic representation showing a basic mechanism of AI verification and learning in accordance with the present embodiment. FIG. 10 shows the relationship between the advanced driving support system and the 3D graphic generation system. FIG. 11 is a schematic diagram for showing the overall configuration of the 3D graphic generation system and the advanced driving support system. Meanwhile, in the description of the present embodiment, like reference numbers indicate functionally similar elements as the above first embodiment unless otherwise specified, and therefore no redundant description is repeated.

(Summary of Verification and Learning of Artificial Intelligence in Advanced Driving Support System)

As illustrated in FIG. 9, the basic mechanism of AI verification in accordance with the present embodiment includes a deductive verification system 211, a virtual environment effectiveness evaluation system 210 and an inductive verification system 212. These verification systems 210 to 211 are implemented by the evaluation unit 21a of the 3D application system 2.

The deductive verification system 211 deductively verifies the validity of the functional verification and machine learning of AI using 3D graphics generated in the 3D application system by accumulating evaluation with reference to the evaluation axis data which is generated by quantitatively calculating the matching degree between the known light distribution theoretical values and the in-situ theoretical values described in the first embodiment.

On the other hand, the inductive verification system 212 serves as a comparison unit which inputs 3D graphics drawn by the 3D application system 2 to a deep learning recognition unit 6 which is an artificial intelligence having learned teacher data by the use of actually photographed materials, and compares reaction of the deep learning recognition unit 6 to the actually photographed materials with reaction of the deep learning recognition unit 6 to the 3D graphics. Specifically speaking, the inductive verification system 212 generates 3D graphics which have the same motif as the actually photographed materials input to the deep learning recognition unit 6 as teacher data, compares the reaction of the deep learning recognition unit 6 to the actually photographed materials with the reaction of the deep learning recognition unit 6 to the 3D graphics which have the same motif as the actually photographed materials, and inductively verifies the validity of the functional verification and machine learning of AI using 3D graphics generated in the 3D application system by proving the identity of these reactions.

On the other hand, the virtual environment effectiveness evaluation system 210 matches the verification result of the deductive verification system 211 with the verification result of the inductive verification system 212 to perform comprehensive evaluation on the basis of both the verification results. By this configuration, the system verification utilizing a running video and space data is performed by evaluating the effectiveness of verification and learning performed with a virtual environment built by the 3D application system 2, and proving the effectiveness of performing verification and learning by the use of a rare case reproduced as 3D graphics which cannot be controlled by human being and which does not commonly occur in a real world.

(Summary of Real Time Simulation Loop)

Then, as illustrated in FIG. 10, in the case of the present embodiment, the verification and learning of the advanced driving support system can be performed by coordinating the 3D graphic generation system with the advanced driving support system to build a real time simulation loop. Namely, this real time simulation loop performs the verification and learning of the artificial intelligence by synchronizing creation of 3D graphics with AI image analysis, behavior control of the advanced driving support system on the basis of the image analysis and the change of 3D graphics in response to the behavior control, reproducing an virtual environment in which the situation to be verified can be controlled, and inputting the virtual environment to the advanced driving support system.

More specifically speaking, the rendering unit 251 of the 3D application system 2 renders 3D graphics reproducing the situation that a vehicle object D3a is running in the environment to be verified (S701), and the 3D graphics are input to the deep learning recognition unit 6 of the advanced driving support system. The deep learning recognition unit 6, to which this 3D graphics are input, performs image analysis by AI, recognizes the environment that a vehicle is running, and inputs control signals for driving support to a behavior simulation unit 7 (S702).

In response to the control signals, the behavior simulation unit 7 simulates the behavior of the vehicle, i.e., accelerator, brake, handle and the like in the same manner as in driving simulation on the basis of actually photographed materials (S703). The result of this behavior simulation is fed back to the 3D application system 2 as behavior data. Receiving this behavior data, the object control unit 254 of the 3D application system 2 changes the behavior of the object (the vehicle object D3a) in the virtual space 4 by the same process as in environment interference in a game engine (S704), and the rendering unit 251 changes 3D graphics on the basis of environment change information corresponding to the change of the object. The changed 3D graphics are input to the advanced driving support system (S701).

(Construction of Artificial Intelligence Verification and Learning System by Real Time Simulation Loop)

Next is an explanation of the specific construction of an artificial intelligence verification and learning system in the advanced driving support system on the basis of the real time simulation loop in accordance with the present embodiment.

(1) Raw Material Photographing Apparatus

As shown in FIG. 11, this verification and learning system acquires a video image photographed by a vehicle mounted camera as an actual site scenery 3 in a real world to be the background of a virtual space in the material photographing apparatus 10, builds the real time simulation loop as described above, and provides interactive video content corresponding to the behavior simulation to the advanced driving support system from the 3D application system 2.

In the case of the present embodiment, the material photographing apparatus 10 is provided with the vehicle mounted camera 11a in place of the full-sky sphere camera 11. The vehicle mounted camera 11a is a camera of the same type as the vehicle mounted camera mounted on a vehicle model which is the object of behavior simulation, or a camera which can reproduce the real camera profile.

(2) 3D Application System

In the case of the present embodiment, the 3D application system 2 is connected to the behavior simulation unit 7 of the advanced driving support system through the input interface 23 to receive the behavior data from the behavior simulation unit 7. Also, the 3D application system 2 is connected to the deep learning recognition unit 6 of the advanced driving support system through the output interface 24 to output 3D graphics generated by the 3D application system 2 to the deep learning recognition unit 6 of the advanced driving support system.

In the case of the present embodiment, the rendering unit 251 synthesizes, on the photographic material, the vehicle D3a which is the object of the behavior simulation in the advanced driving support system as a three-dimensional object, and draws a photographing scene as 3D graphics by the virtual vehicle mounted camera 41a mounted on the vehicle with a set of picture elements which can be two-dimensionally displayed. The information for use in this rendering includes the shape of an object, the view point from which the object is viewed, surface texture of the object (information about texture mapping), a light source, shading conditions and the like. A three-dimensional object such as the vehicle D3a is synthesized with a photographic material, which is photographed by the material image photographing unit 12a, and drawn in order that it can be two-dimensionally displayed, on the basis of lighting settings set by the environment reproduction unit 252 and the control by an object control unit 254 in accordance with the behavior data output from the behavior simulation unit 7.

The environment reproduction unit 252 adds real camera profile information to the photographing settings of the virtual vehicle mounted camera D41a which is arranged in the virtual space 4 to photograph a three-dimensional object, and adjusts the photographing settings in order to make the characteristics of the virtual vehicle mounted camera 41a match the characteristics of the vehicle mounted camera 11a which is actually used in the place.

A photographic material generation unit 253 is a module for generating or acquiring a photographic material which is a still image or a motion picture to be used as a background of the virtual space. This photographic material as acquired is a 3D material which is photographed by the material image photographing unit 12a or created by a 3D material creation application executed by the application execution unit 21.

The object control unit 254 is a module for generating a virtual three-dimensional object arranged in the virtual space 4, and making the three-dimensional object move in response to user operations. Specifically, in the case of the present embodiment, while moving the vehicle D3a and the like as the three-dimensional objects on the basis of the behavior data input from the behavior simulation unit 7 through the input interface 23, the object control unit 254 calculates the relationship to the view point of the virtual vehicle mounted camera 41a, the light source 42 and the background image D2 as the background in the virtual space 4. The rendering unit 251 generates the background image D2 with the view point of the virtual vehicle mounted camera 41a as a center, i.e., a view point position of a user, and synthesizes and draws other three-dimensional objects (architecture such as a building, a walker and the like) on the background image D2 as generated on the basis of the control of this object control unit 254.

(3) Evaluation Unit

The evaluation unit 21a is a module for quantitatively calculating the matching degree between known light distribution theoretical values and in-situ theoretical values to generate evaluation axis data, and evaluating, when compositing a material photographed at the work site and a rendered 3D material with reference to this evaluation axis data, the matching therebetween with respect to light distribution and image characteristics. In the case of the present embodiment, the evaluation unit 21a is provided with a theoretical value generation unit 21b.

This theoretical value generation unit 21b is a module for generating theoretical values from which are deducted the specific characteristics of a camera (real camera), which physically exists, on the basis of the characteristics of an image which are photographed by the real camera and the specific characteristics of the real camera. In the case of the present embodiment, the theoretical value generation unit 21b generates known light distribution theoretical values relating to an image obtained by photographing a known material, as an object whose physical properties are known, by using a real camera under a known light distribution condition, and in-situ theoretical values relating to an image obtained by photographing this known material at the work site.

On the other hand, as illustrated in FIG. 9, the evaluation unit 21a in accordance with the present embodiment includes the deductive verification system 211, the virtual environment effectiveness evaluation system 210 and the inductive verification system 212, as a mechanism of verifying the deep learning recognition unit 6. Then, the deductive verification system 211 deductively verifies the validity of the functional verification and machine learning of AI using 3D graphics generated in the 3D application system by accumulating evaluation with reference to the evaluation axis data which is generated by quantitatively calculating the matching degree between the known light distribution theoretical values and the in-situ theoretical value. On the other hand, the inductive verification system 212 compares reaction of the deep learning recognition unit 6 to the actually photographed materials with reaction of the deep learning recognition unit 6 to the 3D graphics, and inductively verifies the validity of the functional verification and machine learning of the artificial intelligence using 3D graphics in the deep learning recognition unit 6.

Incidentally, the above deductive verification system 211 digitalizes the similarity degree between an actually photographed image and a CG image by PSNR (Peak Signal to Noise Ratio) and SSIM (Structural Similarity Index for Image) which have broadly been used as an objective evaluation scale of image evaluation.

More specifically speaking, PSNR is defined in the following equation, and the greater the value of PSNR is, the smaller the deterioration is such that it is evaluated that the image quality is high (low noise).

$$PSNR = 10 {log}_{10} \frac{{MAX}^{2}}{MSE} \\ \begin{matrix}MSE ( Mean Square Error ) \text{:} sum of squares of pixel values \\ MAX \text{:} maximum of pixel values ( \begin{matrix}MAX = 255 in the case \\ of 8 \text{-} bit images\end{matrix} )\end{matrix} \qquad [ equation 1 ]$$

On the other hand, in contrast to PSNR, SSIM is an evaluation method designed to accurately index human senses and defined in the following equation, and it is evaluated that the image quality is high when SSIM is “no lower than 0.95”.

$$SSIM = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \\ \begin{matrix}μ x , μ y \text{:} averages of x , y image ; \\ σ x , σ y \text{:} variances of x , y image\end{matrix} \\ σ xy \text{:} covariance of x and y ; C 1 , C 2 \text{:} constants \qquad [ equation 2 ]$$

The virtual environment effectiveness evaluation system 210 is a module for matching the verification result of the deductive verification system 211 with the verification result of the inductive verification system 212 to perform comprehensive evaluation on the basis of both the verification results. For example, this evaluation is displayed in order that the verification results can be compared with each other as shown in the following table. Incidentally, table 1 shows examples of evaluation with follow light, and table 2 shows examples of evaluation with back light.

TABLE 1

| SNR (R) | SNR (G) | SNR (B) |
|---|---|---|
| 32.137 dB | 34.657 dB | 31.839 dB |
| SSIM (R) | SSIM (G) | SSIM (B) |
| 0.979 | 0.988 | 0.979 |

TABLE 2

| SNR (R) | SNR (G) | SNR (B) |
|---|---|---|
| 34.988 dB | 35.537 dB | 33.450 dB |
| SSIM (R) | SSIM (G) | SSIM (B) |
| 0.981 | 0.988 | 0.986 |

If these evaluation values fall within a predetermined range, it is determined that the actually photographed materials and the CG materials are approximate, and while learning data is obtained by learning with actually photographed materials as teacher data, it is verified that CG images created by the 3D application system 2 as explained in the above first embodiment can be used as teacher data or learning data in the same manner as actually photographed materials.

The advanced driving support system is composed mainly of the behavior simulation unit 7 and the deep learning recognition unit 6 to which is input, from the rendering unit 251 of the 3D application system 2, the 3D graphics reproducing the situation that a vehicle object D3a is running in the environment to be verified.

The deep learning recognition unit 6 is a module for performing AI image analysis of a real photographed video image or 3D graphics as input, recognizing the environment that a vehicle is running and an obstacle in the video image, and inputting control signals for driving support to the behavior simulation unit 7. The 3D graphics created by the 3D application system 2 are acquired through the output interface 24 of the 3D application system 2. Also, 3D graphics of the same motif as an existing real photographed video image is input to the deep learning recognition unit 6 as verification data, and 3D graphics reproducing a rare situation which does not commonly occur is input to the deep learning recognition unit 6 as teacher data. The functional verification can be performed with reference to the recognition ratio of the verification data, and machine learning can be performed by the use of teacher data.

The behavior simulation unit 7 is a module for receiving the control signals from the deep learning recognition unit 6 and simulating the behavior of the vehicle, i.e., accelerator, brake, handle and the like. The result of this behavior simulation of the behavior simulation unit 7 is fed back to the 3D application system 2 as behavior data through the input interface 23.

(4) Deep Learning Recognition Unit

The deep learning recognition unit 6 is a module for performing image recognition by the so-called deep learning. This deep learning is recognized to have a usefulness in many fields, and practical use thereof has been developed. AI programs having deep learning functionality have won victories over world champions of igo, shogi and chess. Also in the field of image recognition, as compared with other algorithms, a number of more excellent results have been reported in societies and the like. Moves are afoot to introduce such deep learning recognition for realizing an automatic driving system of an automobile by recognizing and detecting a variety of obstacles such as an opposite running vehicle, a walker, a traffic signal and a pylon with a high degree of accuracy.

Also in the case of the present embodiment, an image synthesized with a real photographed video image and a CG image is used as learning data for functional verification in order to realize an automatic driving system. Specifically, as illustrated in FIG. 11, image recognition of 3D graphics synthesized image D61 is performed in accordance with a predetermined deep learning algorithm in the deep learning recognition unit 6 to which is input the 3D graphics synthesized image D61 which is created by the 3D application system 2, followed by outputting deep learning recognition result D62. In a situation that an automatic drive vehicle is running on a road, for example, the deep learning recognition result D62 is a region of an object such as a vehicle, a walker, a traffic signal, a pylon or the like. Incidentally, this region is called ROI (Region of Interest) and indicated by the XY coordinates of the upper left and lower right points of a rectangular.

In the case of the present embodiment, the algorithm implemented in the deep learning recognition unit 6 is implemented for a learning and recognition system and consists of multi-layered neural network, which particularly has three or more layers, inspired by the mechanism of human brains. When data such as image data or the like is input to this recognition system, the data is propagated in order from the first layer so that learning is repeated in order in each subsequent layer. In this process, the feature amount in the image is automatically calculated.

This feature amount is an essential variable necessary for resolution of a problem to characterize a particular concept. It has been known that if this feature amount can be extracted, the problem can be resolved to obtain a substantial advantage in pattern recognition and image recognition. In 2012, Google Brain developed by Google Inc. learned the concept of cat and succeeded automatic recognition of faces of cats. At the present, this deep learning has occupied a principal position in the AI study, and applied to every field in society. In the case of the automatic driving system of an automobile which is the topic of the present embodiment, it is expected in the future that a vehicle having AI functionality can perform safety running by recognizing external factors such as weather, other vehicles and obstacles during running.

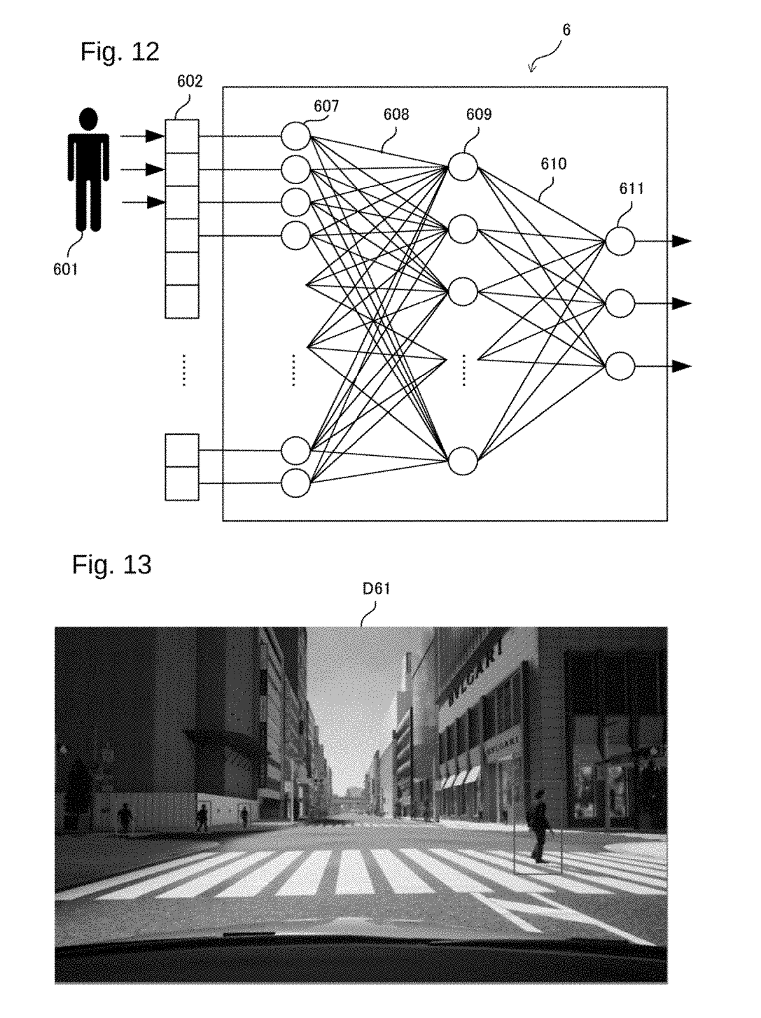

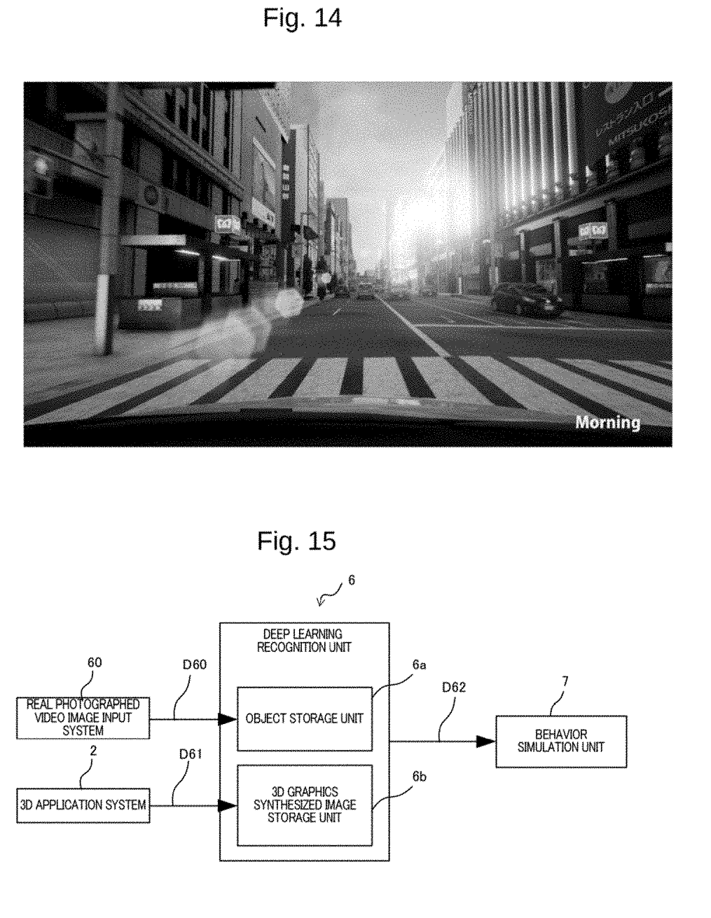

Also in the deep learning recognition unit 6, the 3D graphics synthesized image D61 is input to extract a plurality of feature points from the image and recognize an object by a hierarchical combination pattern of the extracted feature points. The outline of this recognition process is shown in FIG. 12. As illustrated in the same figure, the deep learning recognition unit 6 is implemented with a recognition function module which is a multi-class identification device having settings of a plurality of objects and capable of detecting an object 601 (“a person” in this case) including particular feature points from among the plurality of objects. This recognition function module includes input units (input layer) 607, first weighting factors 608, hidden units (hidden layer) 609, second weighting factors 610 and output units (output layer) 611.

A plurality of feature vectors 602 are input to the input units 607. The first weighting factors 608 are used to weight the outputs of the input units 607. The hidden units 609 nonlinearly convert the linear combination of the outputs of the input units 607 and the first weighting factors 608. The second weighting factors 610 are used to weight the outputs of the hidden units 609. The output units 611 calculate an identification probability of each class (for example, vehicle, walker, motorbike and the like). In this case, the number of the output units 611 is three, the present invention is not limited thereto. The number of the output units 611 equals the number of objects which can be detected by the object identification device. By increasing the number of the output units 611, the object identification device can detect an increased number of objects, for example, two-wheel vehicle, road sign, baby car and the like in addition to vehicle, walker and motorbike.

The deep learning recognition unit 6 in accordance with the present embodiment is an example of a three-layer neural network, and the object identification device performs learning of the first weighting factors 608 and the second weighting factors 610 by the use of error inverse propagation method. Alternatively, the deep learning recognition unit 6 is not limited to such a neural network, but may be a multi-layer perceptron or a deep neural network including a plurality of hidden layers. In this case, the object identification device may learn the first weighting factors 608 and the second weighting factors 610 by deep learning. Also, since the deep learning recognition unit 6 has the object identification device which is a multi-class identification device, for example, it is possible to detect a plurality of objects such as vehicle, walker, motorbike and the like.

FIG. 13 shows an example in which walkers are recognized and detected in the 3D graphics synthesized image D61 by a deep learning technique. Image areas surrounded by rectangles indicate walkers which are accurately detected from a place near own vehicle to a place remote from own vehicle. A walker surrounded by the rectangle is output as information of a deep learning recognition result D62 which is then input to the behavior simulation unit 7.

Also, as illustrated in FIG. 15, the deep learning recognition unit 6 in accordance with the present embodiment is provided with an object storage unit 6a for verification and a 3D graphics synthesized image storage unit 6b.

The object storage unit 6a is a storage device for storing a node which is a recognition result recognized by a usual deep learning recognition process. This usual deep learning recognition process includes image recognition of a real photographed video image D60 which is input from an existing real photographed video image input system 60 provided in the advanced driving support system.

On the other hand, the 3D graphics synthesized image storage unit 6b is a storage device for storing a node which is a recognition result recognized by a deep learning recognition process on the basis of 3D graphics. More specifically speaking, while the deep learning recognition unit 6 performs deep learning recognition on the basis of the real photographed video image input from a usual vehicle mounted camera and 3D graphics input from the 3D application system 2 to output the deep learning recognition result D62, the recognition rate is improved by 3D graphics having the same motif as actually photographed materials in the 3D graphics synthesized image storage unit 6b in parallel or synchronization with the deep learning operation on the basis of the actually photographed materials.

By this configuration, for example, it is expected to improve the recognition rate of the deep learning recognition unit 6 by making use of either or both of the 3D graphics synthesized image storage unit 6b and the object storage unit 6a which the deep learning recognition unit 6 usually has. While performing a deep learning recognition model with the object storage unit 6a and a deep learning recognition model with the 3D graphics synthesized image storage unit 6b in parallel or synchronization with each other, the inductive verification system 212 performs inductive verification by comparing the outputs of these models corresponding to the same node of the output units 611. As a result of comparison, the output having the higher recognition rate is selected and reflected in the recognition as a learning effect to improve the recognition rate.

(5) Teacher Data Provision Unit

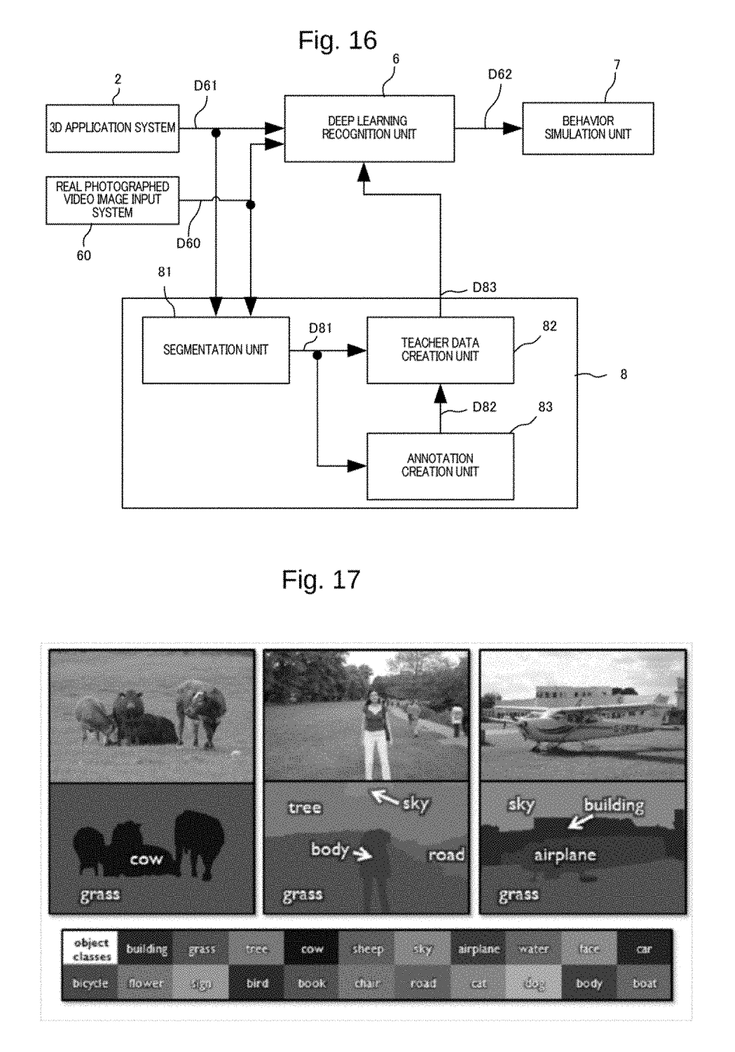

Furthermore, as illustrated in FIG. 16, the deep learning recognition unit 6 can be connected to a teacher data provision unit 8 which provides teacher learning data D83. The teacher data provision unit 8 is provided with a segmentation unit 81 and a teacher data creation unit 82 and an annotation creation unit 83.

The segmentation unit 81 is a module for performing area division (segmentation) for a particular object in an image to be recognized for the purpose of performing deep learning recognition. Specifically speaking, in order to performing deep learning recognition, it is generally required to perform area segmentation of particular objects in an image, and safe automatic driving can be realized by accurately and quickly recognizing various objects such as walker, traffic signal, guard rail, bicycle, roadside tree and the like in addition to an opposite running vehicle during traveling.

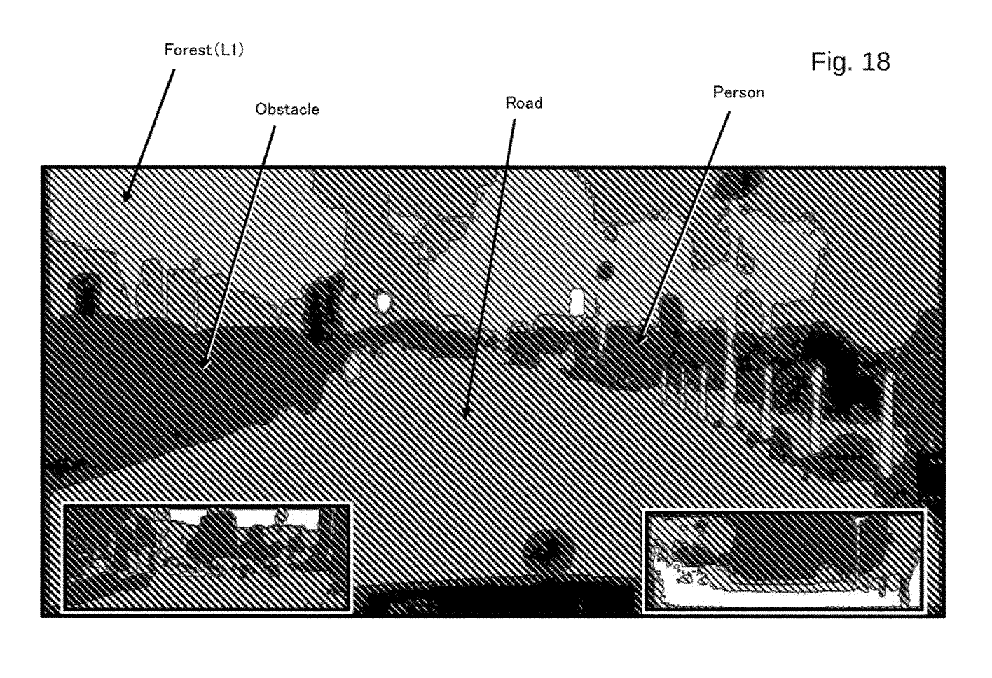

The segmentation unit 81 performs segmentation of a variety of images such as the 3D graphics synthesized image D61 output from the 3D application system 2 and the real photographed video image D60 output from the real photographed video image input system 60 to generate a segmentation image D81 which is a segmentation map in which various subjects are distinguished by color as illustrated in FIG. 17. The segmentation map is provided with color information for assigning a color to each object (subject to be photographed) as illustrated in the lower portion of FIG. 17. For example, grass corresponds to green, airplane corresponds to red, building corresponds to orange, cow corresponds to blue, person corresponds to ocher, and so forth. Also, FIG. 18 shows an example of a segmentation map on a road in which an actually photographed image is located in a lower left position, a sensor taken image is located in a lower right position and an area segmented image is located in a center position, and in which are indicated objects by colors respectively, for example, a road by purple, forest by green, obstacles by blue, a person by red and so forth.

The annotation creation unit 83 is a module for performing an annotation process to associate each area image with a particular object. This annotation is to provide reference information (meta data) as a note for a particular object associated with an area image. The meta data is tagged in a description language such as XML, such that a variety of information items are described with text divided into “meaning of information” and “content of information”. XML provided by the annotation creation unit 83 is used to describe each segmented object (the above “content of information”) and its information (the above “meaning of information”, for example, an area image such as person, vehicle, traffic signal) in association with each other.

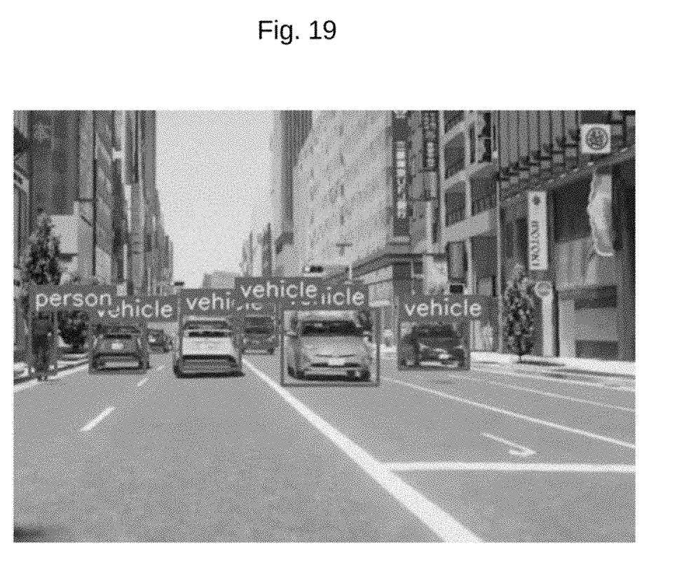

FIG. 19 shows a result of a CG image reproduced of a certain road in which are discriminated by the deep learning recognition technique vehicle area images (vehicle) and a person area image (person) which are extracted as rectangles which are given annotations. The rectangle can be defined by the XY coordinates of the upper left and lower right points thereof.

The annotations described in FIG. 19 as examples are described in an XML language, for example, as <all vehicles>˜</all vehicles> in which information about all the vehicles in the figure is described such that a rectangular area is defined by upper left coordinates of (100,120) and lower right coordinates of (150,150) for a first road Vehicle_1. Likewise, information about all the persons in the figure is described in <all_persons>˜</all_persons>, and for example a rectangular area is defined by upper left coordinates of (200,150) and lower right coordinates of (220,170) for a first road Person 1.

Accordingly, in the case where there are a plurality of vehicles in the image, the vehicles can be created in order from Vehicle-2 as described above. Other objects can be likewise defined, for example, by using, as tag information, “bicycle” for bicycle, “signal” for traffic signal, “tree” for tree.

The real photographed video image D60 output from a camera 10a is, as described in the embodiment 1, synthesized by the rendering unit 251 as the 3D graphics synthesized image D61 which is output from the 3D application system 2. The 3D graphics synthesized image D61 is input to the segmentation unit 81 and segmented by the segmentation unit 81 into colored areas as illustrated in FIG. 17.

Thereafter, after receiving the segmentation image D81 (after colored for distinction), the annotation creation unit 83 describes annotation information D82 in an XML description language and inputs the annotation information D82 to the teacher data creation unit 82. The teacher data creation unit 82 creates teacher data for deep learning recognition by tagging the segmentation image D81 and the annotation information D82. The tagged teacher data D83 is a final output result.

(Artificial Intelligence Verification and Learning Method by Real Time Simulation Loop)

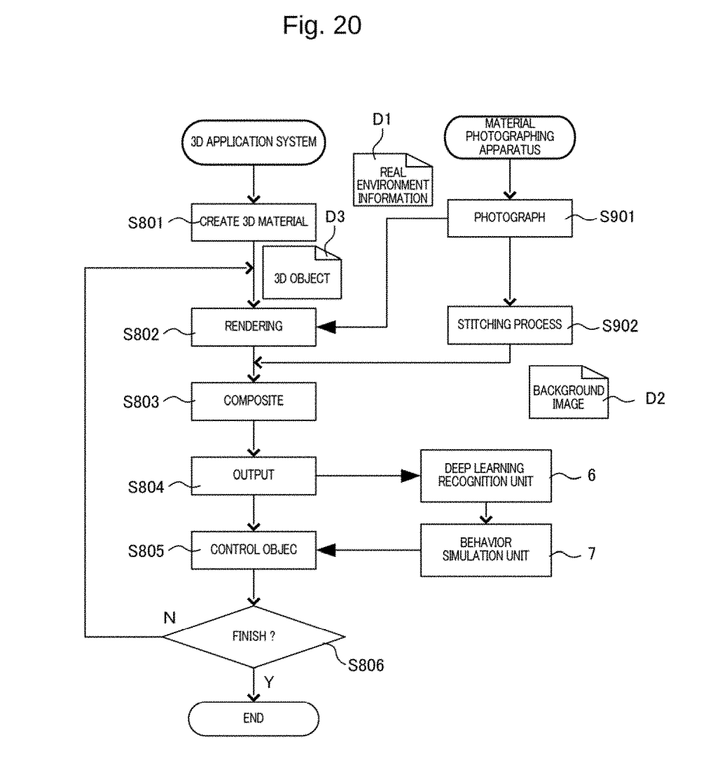

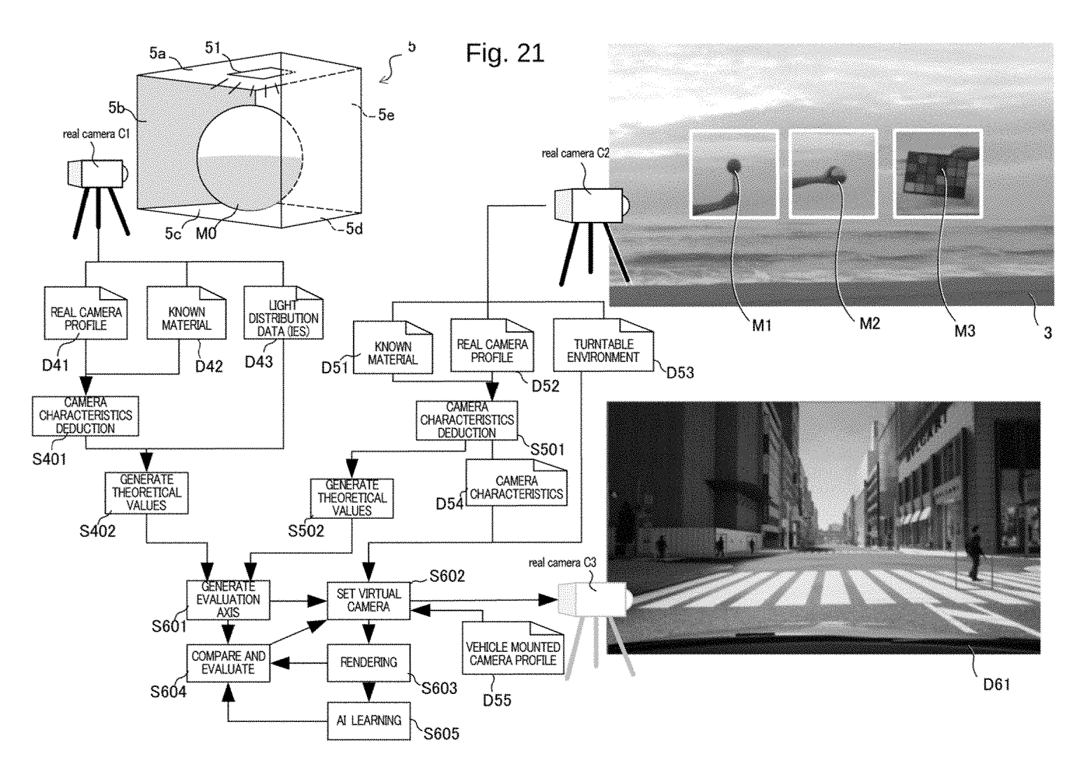

The artificial intelligence verification and learning method can be performed by operating the artificial intelligence verification and learning system having the structure as described above. FIG. 20 shows the artificial intelligence verification and learning system in accordance with the present embodiment. FIG. 21 shows the synthesizing process for generating 3D graphics in accordance with the present embodiment.

(1) 3D Graphics Generation Process

Next is an explanation of a 3D graphics generation process in the real time simulation loop coordinated with the advanced driving support system of the present embodiment. First, 3D materials are created as 3D objects in advance (S801). This 3D material creation is performed by the use of CAD software or graphic software to define a three-dimensional shape, structure, surface texture and the like of an object such as the vehicle D3a with a data set (object file) described by a data structure or a data description language.

While creating this 3D material, a photographic material is photographed (S901). When photographing this photographic material, the material photographing apparatus 10 is used to control the vehicle mounted camera 11a to take photographs and motion picture from the view point of the virtual vehicle mounted camera 41a as a center point. In this case, the real environment acquisition unit 12b acquires turntable environment information D1 containing any of a lighting position, a lighting type, a lighting amount and the number of light sources at the work site where a photographic material is photographed by the material image photographing unit 12a. On the other hand, the material image photographing unit 12a performs a stitching process to splice the photographic materials, which are photographed, together on the full-sky sphere (S902). Then, the background image D2 after the stitching process and the turntable environment data D1 acquired at this time are accumulated in the memory 12e in association with each other, and transmitted to the 3D application system 2 through the external interface 12d.

Next, the three-dimensional object created in step S801 is rendered (S802) in synchronization with behavior simulation in the advanced driving support system. When performing rendering, the rendering unit 251 performs an arithmetic operation of an object file to draw the three-dimensional object D3 which is a set of picture elements which can be two-dimensionally displayed. In this case, the rendering unit 251 performs lighting, which is set by the environment reproduction unit 252, for example by arranging the light source 42 on the basis of the turntable environment data D1.

Then, the rendering unit 251 performs a composite process which combines the three-dimensional object D3 with the background image D2 photographed by the material image photographing unit 12a to draw the combined image in order that it can be two-dimensionally displayed (S803). Thereafter, the background image D2 and the three-dimensional object D3, which are drawn and combined in these steps, are input to the deep learning recognition unit 6 through the output interface 24 (S804). Receiving this input, the deep learning recognition unit 6 performs image analysis by AI, recognizes the environment that a vehicle is running, and inputs control signals for driving support to the behavior simulation unit 7. In response to the control signals, the behavior simulation unit 7 simulates the behavior of the vehicle, i.e., accelerator, brake, handle and the like in the same manner as in driving simulation on the basis of actually photographed materials, and the result of this behavior simulation is fed back to the 3D application system 2 as behavior data. Receiving this behavior data, the object control unit 254 of the 3D application system 2 performs object control (S805) to change the behavior of the vehicle object D3a and other objects in the virtual space 4 by the same process as in environment interference in a game engine. By this object control, the three-dimensional object is moved, deformed and so forth, followed by performing the next rendering process (S802) with the moved/deformed three-dimensional object.

The process in steps S802 to S805 is repeated (“N” in step S806) until the application is finished (“Y” in step S806), and the rendering unit 251 changes 3D graphics on the basis of the result of behavior simulation which is fed back. The changed 3D graphics are continuously synchronized with the behavior simulation in the advanced driving support system and input to the advanced driving support system on a real time base (S701).

(2) Virtual Environment Effectiveness Evaluation Process

Next is a detailed description of verification of artificial intelligence in the above described real time simulation loop. Meanwhile, the overall process flow of the evaluation process of the present embodiment is approximately similar to the matching evaluation process of the above described first embodiment, while differing only in the type and real camera profile of the camera which is used, three-dimensional objects, and verification of AI functionality after rendering, and therefore no redundant description is repeated.

First, in the same manner as the first embodiment, when performing deductive verification, a known material M0 which is an actual object whose physical properties are known is photographed by a real camera C1 which actually exists under a known light distribution condition, and a known material image D43 obtained by this real camera C1, light distribution data D42 of the Cornell box, and a specific profile D41 of the real camera C1 which is used for photographing are input to the evaluation unit 21a.

In addition to this, the actual environment is photographed as a known material image D51 by the real camera C2 which actually exists in the actual site scenery 3. Photographing of this environment is performed under a light source in the actual site scenery 3, and the light distribution thereof is stored as turntable environment data D53. A known material image D51 obtained by this real camera C2, the turntable environment data D53 and the specific profile D52 of the real camera C2 which is a vehicle mounted camera used for photographing are input to the evaluation unit 21a.

Then, the theoretical value generation unit 21b generates known light distribution theoretical values under known light distribution in the Cornell box 5 (S402) by deducting the model specific characteristics of the real camera C1 from the known material image D43 on the basis of the profile D41 of the real camera C1 (S401), and generates in-situ theoretical values under light distribution in the actual site scenery 3 (S502) by deducting the model specific characteristics of the real camera C2 which is the vehicle mounted camera from the known material image D51 on the basis of the profile D52 of the real camera C2 (S501).

Then, the evaluation unit 21a quantitatively calculates the matching degree between the known light distribution theoretical values obtained in step S402 and the in-situ theoretical values obtained in step S502 to generate evaluation axis data. Then, when performing the rendering process S102 and the composite process S103, the virtual camera C3 is set up which is equivalent to the vehicle mounted camera arranged in the virtual space. In this case, the camera characteristics D55 of the vehicle mounted camera are reflected in the settings of the virtual camera C3 (S602), and a rare environment to be verified and the turntable environment data reproducing an environment having the same motif as the actually photographed materials are reflected in the lighting settings in the virtual space under which rendering is performed (S603). At this time, in step S603, three-dimensional objects (a building, a walker and the like) are synthesized on the background image D2, deductively compared and evaluated with reference to the evaluation axis data (S604).

Specifically, the deductive verification system 211 deductively verifies the validity of the functional verification and machine learning of AI using 3D graphics generated in the 3D application system by accumulating evaluation with reference to the evaluation axis data which is generated by quantitatively calculating the matching degree between the known light distribution theoretical values and the in-situ theoretical values described.

On the other hand, 3D graphics generated by rendering in step S603 is provided for AI learning in the advanced driving support system (S605) to perform inductive verification. Specifically, 3D graphics drawn in step S603 are input to the deep learning recognition unit 6 which is an artificial intelligence having learned teacher data by the use of actually photographed materials, and the inductive verification system 212 compares reaction of the deep learning recognition unit 6 to the actually photographed materials with reaction of the deep learning recognition unit 6 to the 3D graphics (S604). In this case, while the 3D application system 2 generates 3D graphics which have the same motif as the actually photographed materials input to the deep learning recognition unit 6 as teacher data, the inductive verification system 212 compares the reaction of the deep learning recognition unit 6 to the actually photographed materials with the reaction of the deep learning recognition unit 6 to the 3D graphics which have the same motif as the actually photographed materials.

Then, in step S604, the virtual environment effectiveness evaluation system 210 matches the verification result of the deductive verification system 211 with the verification result of the inductive verification system 212 to perform comprehensive evaluation on the basis of both the verification results.

(Actions/Effects)

In accordance with the present embodiment, it is possible to build a virtual environment which is effective to perform artificial intelligence verification and learning by applying the 3D graphic generation system explained in the first embodiment to reproduce the reality for input sensors and build a virtual environment in which the situation to be verified can be controlled.

### MODIFICATION EXAMPLES

Incidentally, the embodiments as described above are examples of the present invention. Because of this, the present invention is not limited to the above embodiments, and various modifications are possible in accordance with the design and so forth without departing from the technical spirit of the invention.

### Modification Example 1

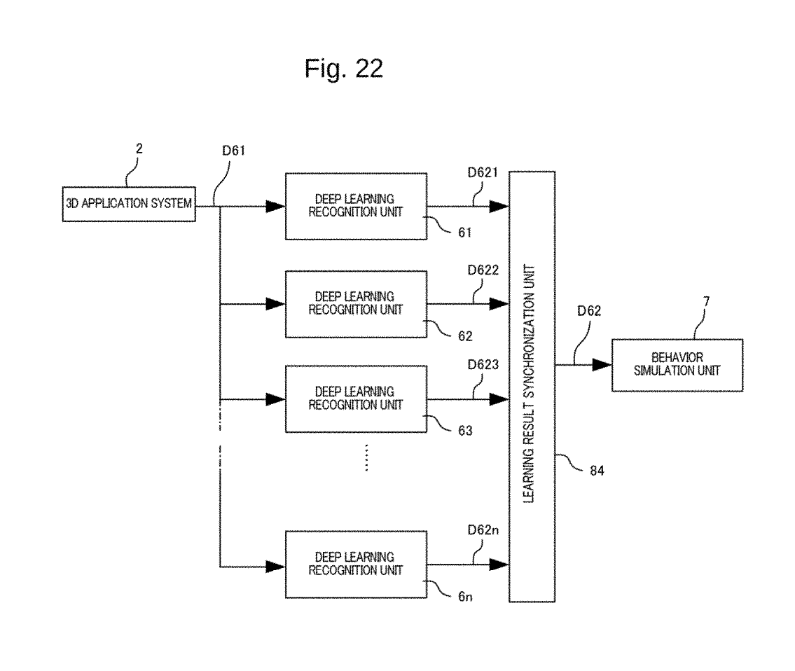

For example, while the vehicle mounted camera 11a of the second embodiment as described above is described as a single camera, the vehicle mounted camera 11a can consist of a plurality of cameras or sensors as illustrated in FIG. 22.

Installation of a plurality of sensors is required for improving safety in automatic driving. Accordingly, it is possible to improve the recognition rate of objects in an image by generating a 3D graphics synthesized image from the images photographed by a plurality of sensors and recognizing these images by a plurality of deep learning recognition units 61 to 6n.

Also, while a plurality of sensors are mounted on one vehicle in the case of the example shown in the above second embodiment, the plurality of deep learning recognition units can recognize the images photographed by sensors mounted on a plurality of vehicles by the similar process. Since there are practically many cases where a plurality of vehicles are running at the same time, the recognition results D621 to D62n of the deep learning recognition units 61 to 6n are synchronized on the same time axis by a learning result synchronization unit 84 to output a final recognition result D62 from the learning result synchronization unit 84.

For example, the synthesized 3D graphics image shown in FIG. 19 is taken by photographing the situation that a plurality of vehicles are running on a road, and the vehicles in this image are created by a 3D graphics technique. The image from the view point of each of these vehicles can be acquired by simulatively installing a sensor in the each vehicle. Then, the synthesized 3D graphics images from the view points of these vehicles are input to the deep learning recognition units 61 to 6n to obtain recognition results.

### Modification Example 2

Next is an explanation of another modification example utilizing a plurality of types of sensors. While the above modification example 1 utilizes sensors of the same type, for example, image sensors of the same type, different types of sensors are installed in the case of this modification example.

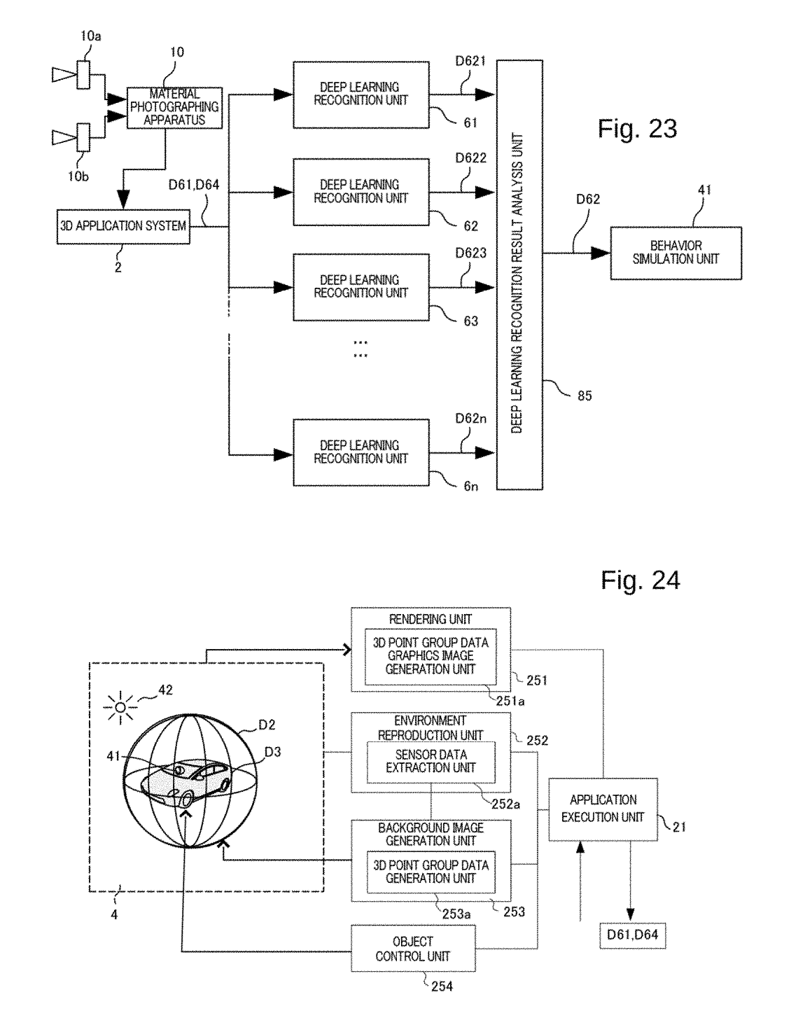

Specifically, as illustrated in FIG. 23, sensors 10a and 10b of different types are connected to the material photographing apparatus 10. In this case, the sensor 10a is a CMOS sensor or a CCD sensor camera for photographing video images in the same manner as in the above embodiments. On the other hand, the sensor 10b is a LiDAR (Light Detection and Ranging) which is a device which detects scattered light of laser radiation emitted in the form of pulses to measure the distances of remote objects. The LiDAR has attracted attention as one of indispensable sensors required for increasing precision of automatic driving.

The sensor 10b (LiDAR) makes use of near-infrared micropulse light (for example, wavelength of 905 nm) as the laser light, and includes a motor, mirrors and lenses for constructing a scanner and an optical system. On the other hand, a light receiving unit and a signal processing unit of the sensor 10b receive reflected light and calculate distances by signal processes. In this case, the LiDAR employs the so-called TOF system (Time of Flight) which emits ultrashort pulses of a rising time of several nano seconds and a light peak power of several tens Watt to an object to be measured, and measures the time t required for the ultrashort pulses to reflect from the object to be measured and return to the light receiving unit. If the distance to the object is L and the velocity of light is c, the distance L is calculated by the following equation.

L=(c×t)/2

The basic operation of this LiDAR system is such that modulated laser light is reflected by a rotating mirror, distributed left and right or rotating by 360° for scanning, and that the laser light as reflected by the object is returned and captured by the detector (the light receiving unit and the signal processing unit). Finally, the captured reflected light is used to obtain point group data indicating signal levels at rotation angles.

Then, in the case of this modification example constructed as described above, the 3D graphics synthesized image D61 based on the video image photographed by the camera 10a is a two-dimensional image which is recognized by the deep learning recognition unit 6.

On the other hand, the point group data acquired by the sensor 10b is processed by a module additionally provided for the point group data in the 3D application system 2. In the case of the present embodiment, there are provided a 3D point group data graphics image generation unit 251a in the rendering unit 251, a sensor data extraction unit 252a in the environment reproduction unit 252, and a 3D point group data generation unit 253a in the photographic material generation unit 253.

Then, with respect to the point group data acquired by the sensor 10b, the sensor data extraction unit 252a extracts sensor data acquired by the sensor 10b, and the sensor data is transferred to the 3D point group data generation unit 253a. The 3D point group data generation unit 253a generates 3D point group data by calculating the distance to the object by the TOF mechanism with reference to reflected light as received on the basis of the sensor data input from the sensor data extraction unit 252a. The object control unit 254 inputs this 3D point group data to the 3D point group data graphics image generation unit 251a together with the object in the virtual space 4, and the 3D point group data is converted to a 3D graphic image.

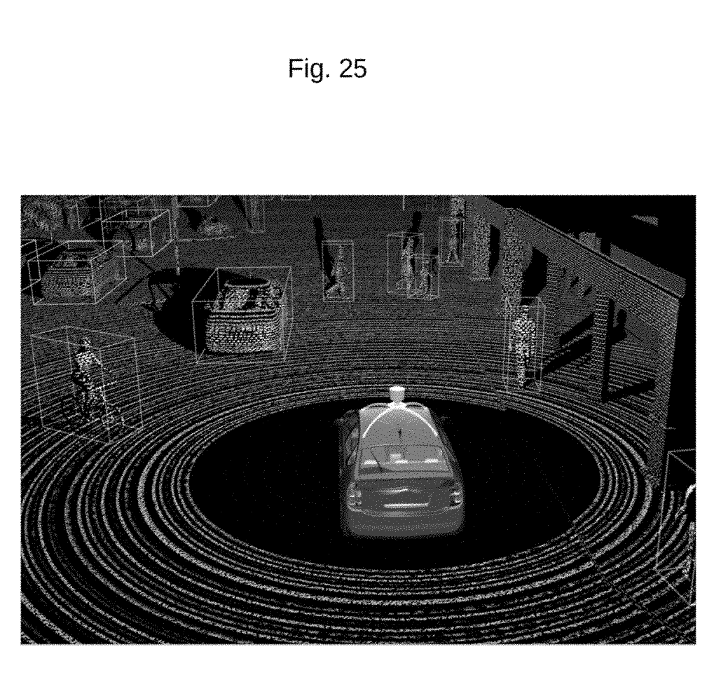

This converted 3D graphic image as a 3D point group data graphic image D64 may be point group data which is obtained by emitting laser light to all directions of 360 degrees from a LiDAR installed, for example, on the running center vehicle shown in FIG. 25 and measuring the reflected light, and the intensity (density) of color indicates the intensity of the reflected light. Incidentally, the area such as a gap in which no substance exists is colored black because there is no reflected light.

As illustrated in FIG. 25, target objects such as an opposite running vehicle, a walker and a bicycle can be acquired from actual point group data as three-dimensional coordinate data, and therefore it is possible to easily generate 3D graphic images of these target objects. Specifically, the 3D point group data graphics image generation unit 251a consistently processes point group data to generate a plurality of polygon data items, and 3D graphics can be drawn by rendering these polygon data items.

Then, the 3D point group data graphic image D64 as generated in this manner is input to the deep learning recognition unit 6, and recognized by recognition means which has performed learning for 3D point group data in the deep learning recognition unit 6. By this configuration, different means is used than the deep learning recognition means which has performed learning for images of image sensors as described in the above embodiment. As a result, even if an oncoming vehicle is very far away so that it is likely that the vehicle cannot be acquired by an image sensor, the LiDAR can acquire the size and profile of the oncoming vehicle even at the front of several hundred meters so that the recognition precision can be improved. As has been discussed above, in accordance with the above modification example, there are provided a plurality of sensors having different characteristics or different device properties, and an analysis unit 85 analyzes recognition results obtained from the outputs of the sensors by the deep learning recognition units 61 to 6n, and outputs the final recognition result D62.

Incidentally, this analysis unit 85 may be arranged outside, for example, in a network cloud. In this case, even in the case where the number of sensors per one vehicle dramatically increases in the future so that the computational load of the deep learning recognition process increases, it is possible to improve processing efficiency by performing processes, which can be handled outside through a network, by a cloud having a large scale computing power and feeding back the results.

Furthermore, while the above modification example is explained with a LiDAR sensor, it is also effective to make use of a millimeter wave sensor or an infrared ray sensor which is effective in the nighttime.

### DESCRIPTION OF REFERENCE SIGNS

C1, C2 . . . real camera
C3 . . . virtual camera
D1, D53 . . . turntable environment data
D2 . . . background image
D3 . . . three-dimensional object
D41, D52 . . . profile
D42 . . . light distribution data
D43, D51 . . . known material image
D54 . . . camera characteristics
D55 . . . vehicle mounted camera characteristic
LAN . . . wired/wireless
M0, M1-M3 . . . known material
Three . . . actual site scenery
4 . . . virtual space
5 . . . Cornell boxes
6 . . . deep learning recognition unit
6a . . . object storage unit
6b . . . 3D graphics synthesized image storage unit
7 . . . behavior simulation unit
8 . . . teacher data provision unit
10 . . . material photographing apparatus
11 . . . full-sky sphere camera
12 . . . motion control device
12a . . . material photographing unit
12b . . . real environment acquisition unit
12c . . . motion control unit
12d . . . external interface
12e . . . memory
21 . . . application execution unit**>
21a . . . evaluation unit
21b . . . theoretical value generation unit
22 . . . external interface
23 . . . input interface
24 . . . output interface
26 . . . memory
41 . . . camera view point
42 . . . light source
51 . . . lighting
60 . . . real photographed video image input system
81 . . . segmentation unit
82 . . . teacher data creation unit
83 . . . annotation creation unit
84 . . . learning result synchronization unit
85 . . . analysis unit
210 . . . virtual environment effectiveness evaluation system
211 . . . deductive verification system
212 . . . induction verification systems
241a . . . display
241b . . . speaker
251 . . . rendering unit
252 . . . environment reproduction unit
253 . . . photographic material generation unit
254 . . . object control unit

1. A 3D graphic generation system comprising:
a material photographing unit which photographs, as a photographic material, a still image or a motion picture of a real object equivalent to a material arranged in a virtual space;
a real environment acquisition unit which acquires turntable environment information containing any of a lighting position, a lighting type, a lighting amount, a lighting color and the number of light sources at a work site where the photographic material is photographed, and real camera profile information which describes specific characteristics of the material photographing unit which is used to photograph the photographic material;
an object control unit which generates a virtual three-dimensional object arranged in the virtual space, and makes the three-dimensional object move in response to user operations;
an environment reproduction unit which acquires the turntable environment data, sets lighting for the three-dimensional object in the virtual space on the basis of the turntable environment data which is acquired, and adds the real camera profile information to photographing settings of a virtual photographing unit which is arranged in the virtual space to photograph the three-dimensional object; and
a rendering unit which synthesizes a three-dimensional object with the photographic material, which is photographed by the material photographing unit, and draws the three-dimensional object in order that the three-dimensional object can be two-dimensionally displayed, on the basis of the lighting and photographing settings set by the environment reproduction unit.

2. The 3D graphic generation system of claim 1 wherein
the material photographing unit has a function to photograph images in multiple directions to form background images in a full-sky sphere as the photographic material, wherein
the real environment acquisition unit has a function to acquire the turntable environment information in the multiple directions and reproduce a light source in a real space including the work site, and wherein
the rendering unit joins the background images in the form of a full-sky spherical image with a view point position of a user as a center, synthesizes and draws the three-dimensional object on the joined full-sky spherical background images.

3. The 3D graphic generation system of claim 1 further comprising:
a known light distribution theoretical value generation unit which generates, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;
an in-situ theoretical value generation unit which generates in-situ theoretical values at the work site, from which is deducted a characteristic specific to the material photographing unit, on the basis of an image characteristic of a photographic material obtained by photographing the known material at the work site and the real camera profile information relating to the material photographing unit; and
an evaluation unit which generates evaluation axis data by quantitatively calculating the matching degree between the known light distribution theoretical values and the in-situ theoretical values, wherein
when the three-dimensional object is synthesized with the photographic material, the rendering unit performs a process to match the image characteristics of the photographic raw material and three-dimensional object with reference to the evaluation axis.

4. An artificial intelligence verification and learning system which performs predetermined motion control on the basis of image recognition through a camera sensor, comprising:
a material photographing unit which photographs, as a photographic material, a still image or a motion picture of a real object equivalent to a material arranged in a virtual space;
a real environment acquisition unit which acquires turntable environment information containing any of a lighting position, a lighting type, a lighting amount, a lighting color and the number of light sources at a work site where the photographic material is photographed, and real camera profile information which describes specific characteristics of the camera sensor;
an object control unit which generates a virtual three-dimensional object arranged in the virtual space, and makes the three-dimensional object move on the basis of the motion control by the artificial intelligence;
an environment reproduction unit which acquires the turntable environment data, sets lighting for the three-dimensional object in the virtual space on the basis of the turntable environment data which is acquired, and adds the real camera profile information to photographing settings of a virtual photographing unit which is arranged in the virtual space to photograph the three-dimensional object;
a rendering unit which synthesizes a three-dimensional object with the photographic material, which is photographed by the material photographing unit, and draws the three-dimensional object in order that the three-dimensional object can be two-dimensionally displayed, on the basis of the lighting and photographing settings set by the environment reproduction unit; and
an output unit which inputs graphics drawn by the rendering unit to the artificial intelligence.

5. The artificial intelligence verification and learning system of claim 4 further comprising:
a known light distribution theoretical value generation unit which generates, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;
an in-situ theoretical value generation unit which generates in-situ theoretical values at the work site, from which is deducted a characteristic specific to the material photographing unit, on the basis of an image characteristic of a photographic material obtained by photographing the known material at the work site and the real camera profile information relating to the material photographing unit; and
an evaluation unit which generates evaluation axis data by quantitatively calculating the matching degree between the known light distribution theoretical values and the in-situ theoretical values.

6. The artificial intelligence verification and learning system of claim 4 further comprising:
a comparison unit which inputs graphics drawn by the rendering unit to the artificial intelligence having learned teacher data by the use of actually photographed materials, and compares reaction of the artificial intelligence to the actually photographed materials with reaction of the artificial intelligence to the graphics.

7. The artificial intelligence verification and learning system of claim 4 further comprising:
a segmentation unit which performs area segmentation for a particular object in an image to be recognized with respect to the graphics drawn by the rendering unit;
an annotation creation unit which associates an area image which is area segmented with a particular object; and
a teacher data creation unit which creates teacher data for learning by associating the area image with annotation information.

8. The artificial intelligence verification and learning system of claim 4 further comprising:
a sensor unit having a different characteristic than the camera sensor, wherein
the real environment acquisition unit acquires the detection result of the sensor unit having the different characteristic together with the turntable environment information, wherein
the rendering unit generates a 3D graphics image on the basis of information obtained from each of the sensors having the different characteristics, and wherein
The artificial intelligence comprises:
a unit which performs deep learning recognition by receiving 3D graphics images;
a unit which outputs a deep learning recognition result for each of the sensors; and
a unit which analyzes the deep learning recognition result for each of the sensors and selects one or more result from among the deep learning recognition results.

9. A 3D graphic generation program causing a computer to function as:
a material photographing unit which photographs, as a photographic material, a still image or a motion picture of a real object equivalent to a material arranged in a virtual space;
a real environment acquisition unit which acquires turntable environment information containing any of a lighting position, a lighting type, a lighting amount, a lighting color and the number of light sources at a work site where the photographic material is photographed, and real camera profile information which describes specific characteristics of the material photographing unit which is used to photograph the photographic material;
an object control unit which generates a virtual three-dimensional object arranged in the virtual space, and makes the three-dimensional object move in response to user operations;
an environment reproduction unit which acquires the turntable environment data, sets lighting for the three-dimensional object in the virtual space on the basis of the turntable environment data which is acquired, and adds the real camera profile information to photographing settings of a virtual photographing unit which is arranged in the virtual space to photograph the three-dimensional object; and
a rendering unit which synthesizes a three-dimensional object with the photographic material, which is photographed by the material photographing unit, and draws the three-dimensional object in order that the three-dimensional object can be two-dimensionally displayed, on the basis of the lighting and photographing settings set by the environment reproduction unit.

10. The 3D graphic generation program of claim 9 wherein
the material photographing unit has a function to photograph images in multiple directions to form background images in a full-sky sphere as the photographic material, wherein
the real environment acquisition unit has a function to acquire the turntable environment information in the multiple directions and reproduce a light source in a real space including the work site, and wherein
the rendering unit joins the background images in the form of a full-sky spherical image with a view point position of a user as a center, synthesizes and draws the three-dimensional object on the joined full-sky spherical background images.

11. The 3D graphic generation program of claim 9 causing the computer to further function as:
a known light distribution theoretical value generation unit which generates, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;
an in-situ theoretical value generation unit which generates in-situ theoretical values at the work site, from which is deducted a characteristic specific to the material photographing unit, on the basis of an image characteristic of a photographic material obtained by photographing the known material at the work site and the real camera profile information relating to the material photographing unit; and
an evaluation unit which generates evaluation axis data by quantitatively calculating the matching degree between the known light distribution theoretical values and the in-situ theoretical values, wherein
when the three-dimensional object is synthesized with the photographic material, the rendering unit performs a process to match the image characteristics of the photographic raw material and three-dimensional object with reference to the evaluation axis, followed by performing the synthesizing.

12. An artificial intelligence verification and learning program for performing predetermined motion control on the basis of image recognition through a camera sensor and causing a computer to function as:
a material photographing unit which photographs, as a photographic material, a still image or a motion picture of a real object equivalent to a material arranged in a virtual space;
a real environment acquisition unit which acquires turntable environment information containing any of a lighting position, a lighting type, a lighting amount, a lighting color and the number of light sources at a work site where the photographic material is photographed, and real camera profile information which describes specific characteristics of the camera sensor;
an object control unit which generates a virtual three-dimensional object arranged in the virtual space, and makes the three-dimensional object move on the basis of the motion control by the artificial intelligence;
an environment reproduction unit which acquires the turntable environment data, sets lighting for the three-dimensional object in the virtual space on the basis of the turntable environment data which is acquired, and adds the real camera profile information to photographing settings of a virtual photographing unit which is arranged in the virtual space to photograph the three-dimensional object;
a rendering unit which synthesizes a three-dimensional object with the photographic material, which is photographed by the material photographing unit, and draws the three-dimensional object in order that the three-dimensional object can be two-dimensionally displayed, on the basis of the lighting and photographing settings set by the environment reproduction unit; and
an output unit which inputs graphics drawn by the rendering unit to the artificial intelligence.

13. The artificial intelligence verification and learning program of claim 12 causing the computer to further function as:
a known light distribution theoretical value generation unit which generates, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;
an in-situ theoretical value generation unit which generates in-situ theoretical values at the work site, from which is deducted a characteristic specific to the material photographing unit, on the basis of an image characteristic of a photographic material obtained by photographing the known material at the work site and the real camera profile information relating to the material photographing unit; and
an evaluation unit which generates evaluation axis data by quantitatively calculating the matching degree between the known light distribution theoretical values and the in-situ theoretical values.

14. The artificial intelligence verification and learning program of claim 12 causing the computer to further function as:
a comparison unit which inputs graphics drawn by the rendering unit to the artificial intelligence having learned teacher data by the use of actually photographed materials, and compares reaction of the artificial intelligence to the actually photographed materials with reaction of the artificial intelligence to the graphics.

15. The artificial intelligence verification and learning program of claim 12 causing the computer to further function as:
a segmentation unit which performs area segmentation for a particular object in an image to be recognized with respect to the graphics drawn by the rendering unit;
an annotation creation unit which associates an area image which is area segmented with a particular object; and
a teacher data creation unit which creates teacher data for learning by associating the area image with annotation information.

16. The artificial intelligence verification and learning program of claim 12, wherein
a sensor unit having a different characteristic than the camera sensor is provided, wherein
the real environment acquisition unit acquires the detection result of the sensor unit having the different characteristic together with the turntable environment information, wherein
the rendering unit generates a 3D graphics image on the basis of information obtained from each of the sensors having the different characteristics, and wherein
The artificial intelligence comprises:
a unit which performs deep learning recognition by receiving 3D graphics images;
a unit which outputs a deep learning recognition result for each of the sensors; and
a unit which analyzes the deep learning recognition result for each of the sensors and selects one or more result from among the deep learning recognition results.

17. A 3D graphic generation method comprising:
a process of photographing, as a photographic material, a still image or a motion picture of a real object equivalent to a material arranged in a virtual space by a material photographing unit, and acquiring, by a real environment acquisition unit, turntable environment information containing any of a lighting position, a lighting type, a lighting amount, a lighting color and the number of light sources at a work site where the photographic material is photographed, and real camera profile information which describes specific characteristics of the material photographing unit which is used to photograph the photographic material;
a process of, by an environment reproduction unit, acquiring the turntable environment data, setting lighting for the three-dimensional object in the virtual space on the basis of the turntable environment data which is acquired, and adding the real camera profile information to photographing settings of a virtual photographing unit which is arranged in the virtual space to photograph a three-dimensional object; and
a process of, by an object control unit, generating a virtual three-dimensional object arranged in the virtual space, and makings the three-dimensional object move in response to user operations; and
a process of, by a rendering unit, synthesizing a three-dimensional object with the photographic material, which is photographed by the material photographing unit, and drawing the three-dimensional object in order that the three-dimensional object can be two-dimensionally displayed, on the basis of the lighting and photographing settings set by the environment reproduction unit.

18. The 3D graphic generation method of claim 17 wherein
the material photographing unit has a function to photograph images in multiple directions to form background images in a full-sky sphere as a photographic material, wherein
the real environment acquisition unit has a function to acquire the turntable environment information in the multiple directions and reproduce a light source in a real space including the work site, and wherein
the rendering unit joins the background images in the form of a full-sky spherical image with a view point position of a user as a center, synthesizes and draws the three-dimensional object on the joined full-sky spherical background images.

19. The 3D graphic generation method of claim 17 further comprising:
a process of, by a known light distribution theoretical value generation unit, generating, under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;
a process of, by an in-situ theoretical value generation unit, generating in-situ theoretical values at the work site, from which is deducted a characteristic specific to the material photographing unit, on the basis of an image characteristic of a photographic material obtained by photographing the known material at the work site and the real camera profile information relating to the material photographing unit; and
a process of, by an evaluation unit, generating evaluation axis data by quantitatively calculating the matching degree between the known light distribution theoretical values and the in-situ theoretical values, wherein
when the three-dimensional object is synthesized with the photographic material, the rendering unit performs a process to match the image characteristics of the photographic raw material and three-dimensional object with reference to the evaluation axis, followed by performing the synthesizing.

20. An artificial intelligence verification and learning method which performs predetermined motion control on the basis of image recognition through a camera sensor, comprising:
a real environment acquisition step of photographing, by a material photographing unit, a still image or a motion picture of a real object, which is equivalent to a material arranged in a virtual space, and acquiring, by a real environment acquisition unit, turntable environment information containing any of a lighting position, a lighting type, a lighting amount, a lighting color and the number of light sources at a work site where the photographic material is photographed, and real camera profile information which describes specific characteristics of the camera sensor;
an object control step of generating a virtual three-dimensional object arranged in the virtual space and making, by an object control unit, the three-dimensional object move on the basis of the motion control by the artificial intelligence;
an environment reproduction step of acquiring the turntable environment data, setting lighting for the three-dimensional object in the virtual space on the basis of the turntable environment data which is acquired, and adding, by an environment reproduction unit, the real camera profile information to photographing settings of a virtual photographing unit which is arranged in the virtual space to photograph the three-dimensional object;
a rendering step of synthesizing a three-dimensional object with the photographic material, which is photographed by the material photographing unit, and drawing, by a rendering unit, the three-dimensional object in order that the three-dimensional object can be two-dimensionally displayed, on the basis of the lighting and photographing settings set by the environment reproduction unit; and
an output step of inputting, by an output unit, graphics drawn by the rendering unit to the artificial intelligence.

21. The artificial intelligence verification and learning method of claim 20 further comprising:
a known light distribution theoretical value generation step of generating, by a known light distribution theoretical value generation unit under known light distribution, known light distribution theoretical values from which is deducted a characteristic specific to the material photographing unit, on the basis of an image characteristic of a known material image obtained by photographing a known material, as an object whose physical properties are known, with the material photographing unit under a known light distribution condition, and the real camera profile information relating to the material photographing unit;
an in-situ theoretical value generation step of generating, by an in-situ theoretical value generation unit, in-situ theoretical values at the work site, from which is deducted a characteristic specific to the material photographing unit, on the basis of an image characteristic of a photographic material obtained by photographing the known material at the work site and the real camera profile information relating to the material photographing unit; and
an evaluation step of generating, by an evaluation unit, evaluation axis data by quantitatively calculating the matching degree between the known light distribution theoretical values and the in-situ theoretical values.

22. The artificial intelligence verification and learning method of claim 20 further comprising:
a comparison step of inputting graphics drawn by the rendering unit to the artificial intelligence having learned teacher data by the use of actually photographed materials, and comparing, by a comparison unit, reaction of the artificial intelligence to the actually photographed materials with reaction of the artificial intelligence to the graphics.

23. The artificial intelligence verification and learning method of claim 20 further comprising:
a step of performing area segmentation for a particular object in an image to be recognized with respect to the graphics drawn by the rendering unit;
a step of associating an area image which is area segmented with a particular object; and
a step of creating teacher data by associating the area image for learning with annotation information.

24. The artificial intelligence verification and learning method of claim 20 wherein
a sensor unit having a different characteristic than the camera sensor is further provided, wherein
the detection result of the sensor unit having the different characteristic is acquired in the real environment acquisition step together with the turntable environment information, wherein
a 3D graphics image is generated in the rendering step on the basis of information obtained from each of the sensors having the different characteristics, and wherein
after the output step, the artificial intelligence
performs deep learning recognition by receiving 3D graphics images,
outputs a deep learning recognition result for each of the sensors, and
analyzes the deep learning recognition result for each of the sensors and selects one or more result from among the deep learning recognition results.
